(19) United States
(12) Patent Application Publication
(10) Pub. No.: US 2025/0274935 A1
(43) Pub. Date: Aug. 28, 2025

(54) ENHANCEMENTS OF DOWNLINK PREEMPTION INDICATION AND UPLINK CANCELATION INDICATION

(71) Applicant: QUALCOMM Incorporated, San Diego, CA (US)

(72) Inventors: Jing LEI, San Diego, CA (US); Kazuki TAKEDA, Minato-ku (JP); Kianoush HOSSEINI, San Diego, CA (US)

(21) Appl. No.: 18/589,210

(22) Filed: Feb. 27, 2024

(51) Int. Cl. H04W 72/1273; H04L 5/00; H04W 72/0453; H04W 72/21

(52) U.S. Cl. CPC H04W 72/1273; H04L 5/0041; H04W 72/0453; H04W 72/21

(57) ABSTRACT

Methods, systems, and devices for wireless communications are described. A user equipment (UE) may receive a control message indicating scheduling information for a downlink message or an uplink message that is scheduled for transmission via a first subband of a first radio frequency spectrum band and via a second subband of a second radio frequency spectrum band. The second subband may be non-contiguous with the first subband, and the first and second subbands may be associated with a virtual cell that supports communications for the UE. The UE may receive a preemption message or a cancellation message indicating that at least a portion of the downlink message or the uplink message is preempted or canceled, and the portion may correspond to the first subband and the second subband. The preemption message or the cancellation message may indicate time-frequency resources that are preempted or canceled.

### FIELD OF TECHNOLOGY

The following relates to wireless communications, including enhancements of downlink preemption indication (DLPI) and uplink cancelation indication (ULCI).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support enhancements of downlink preemption indication (DLPI) and uplink cancelation indication (ULCI). For example, the described techniques relate to a DLPI or an ULCI that enables preemption or cancellation of transmissions that are communicated, or scheduled to be communicated, over multiple non-contiguous subbands. The DLPI or ULCI may indicate time-frequency resources within non-contiguous subbands (e.g., of a virtual cell) that are to be preempted or canceled, utilizing one or more fields or bitmaps in the DLPI or ULCI to indicate such time-frequency resources.

A method for wireless communications by a user equipment (UE) is described. The method may include receiving a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE, monitoring the first subband and the second subband for the downlink message from the virtual cell based on the scheduling information, and receiving a preemption message indicating that at least a portion of the downlink message is preempted, the portion corresponding to the first subband and the second subband.

A UE for wireless communications is described. The UE may include one or more memories storing processor executable code, and one or more processors coupled with the one or more memories. The one or more processors may individually or collectively be operable to execute the code to cause the UE to receive a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE, monitor the first subband and the second subband for the downlink message from the virtual cell based on the scheduling information, and receive a preemption message indicating that at least a portion of the downlink message is preempted, the portion corresponding to the first subband and the second subband.

Another UE for wireless communications is described. The UE may include means for receiving a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE, means for monitoring the first subband and the second subband for the downlink message from the virtual cell based on the scheduling information, and means for receiving a preemption message indicating that at least a portion of the downlink message is preempted, the portion corresponding to the first subband and the second subband.

A non-transitory computer-readable medium storing code for wireless communications is described. The code may include instructions executable by one or more processors to receive a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE, monitor the first subband and the second subband for the downlink message from the virtual cell based on the scheduling information, and receive a preemption message indicating that at least a portion of the downlink message is preempted, the portion corresponding to the first subband and the second subband.

In some examples of the method, UEs, and non-transitory computer-readable medium described herein, receiving the preemption message may include operations, features, means, or instructions for receiving the preemption message via a UE specific search space (USS) for the UE, where a scrambling sequence associated with the preemption message may be based on a UE identifier of the UE.

In some examples of the method, UEs, and non-transitory computer-readable medium described herein, receiving the preemption message may include operations, features, means, or instructions for receiving the preemption message via a common search space (CSS) associated with the UE, where a scrambling sequence associated with the preemption message may be based on a group radio network temporary identifier (RNTI) or a UE identifier of the UE.

In some examples of the method, UEs, and non-transitory computer-readable medium described herein, the portion of the downlink message that may be preempted corresponds to a primary cell (PCell) for the UE and to one or more activated secondary cells (SCells) associated with the UE.

In some examples of the method, UEs, and non-transitory computer-readable medium described herein, the PCell and the one or more activated SCells may be associated with a same physical uplink control channel (PUCCH) group, a same timing advance group (TAG), or both.

In some examples of the method, UEs, and non-transitory computer-readable medium described herein, receiving the preemption message may include operations, features, means, or instructions for receiving an indication of whether the portion of the downlink message that may be preempted occurs before or after reception of the preemption message and an indication of a time period corresponding to the portion of the downlink message that may be preempted.

In some examples of the method, UEs, and non-transitory computer-readable medium described herein, receiving the preemption message may include operations, features, means, or instructions for receiving an indication of a priority of the downlink message relative to one or more other downlink messages, where the preemption of at least the portion of the downlink message may be based on the priority.

In some examples of the method, UEs, and non-transitory computer-readable medium described herein, receiving the preemption message may include operations, features, means, or instructions for receiving a start and length indicator value (SLIV), a resource indicator value (RIV), or both indicative of the portion of the downlink message that may be preempted.

In some examples of the method, UEs, and non-transitory computer-readable medium described herein, receiving the preemption message may include operations, features, means, or instructions for receiving an indication of a bitmap indicating a set of time-frequency resources corresponding to the portion of the downlink message that may be preempted, where the set of time-frequency resources corresponds to both the first subband and the second subband.

In some examples of the method, UEs, and non-transitory computer-readable medium described herein, the bitmap includes a first value indicating that the first subband may be preempted for a duration of time and includes a second value indicating that the second subband may be not preempted for the duration of time.

In some examples of the method, UEs, and non-transitory computer-readable medium described herein, the preemption message includes a first field indicating that both the first subband and the second subband may be at least partially preempted and includes a second field indicating both a first subset of time-frequency resources within the first subband and a second subset of time-frequency resources within the second subband that may be preempted.

A method for wireless communications by a UE is described. The method may include receiving a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE, receiving a cancellation message indicating that at least a portion of the uplink message is canceled based on the scheduling information, the portion corresponding to the first subband and the second subband, and canceling transmission of at least the portion of the uplink message based on the cancellation message.

A UE for wireless communications is described. The UE may include one or more memories storing processor executable code, and one or more processors coupled with the one or more memories. The one or more processors may individually or collectively be operable to execute the code to cause the UE to receive a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE, receive a cancellation message indicating that at least a portion of the uplink message is canceled based on the scheduling information, the portion corresponding to the first subband and the second subband, and cancel transmission of at least the portion of the uplink message based on the cancellation message.

Another UE for wireless communications is described. The UE may include means for receiving a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE, means for receiving a cancellation message indicating that at least a portion of the uplink message is canceled based on the scheduling information, the portion corresponding to the first subband and the second subband, and means for canceling transmission of at least the portion of the uplink message based on the cancellation message.

A non-transitory computer-readable medium storing code for wireless communications is described. The code may include instructions executable by one or more processors to receive a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE, receive a cancellation message indicating that at least a portion of the uplink message is canceled based on the scheduling information, the portion corresponding to the first subband and the second subband, and cancel transmission of at least the portion of the uplink message based on the cancellation message.

In some examples of the method, UEs, and non-transitory computer-readable medium described herein, receiving the cancellation message may include operations, features, means, or instructions for receiving the cancellation message via a USS for the UE, where a scrambling sequence associated with the cancellation message may be based on a UE identifier of the UE.

In some examples of the method, UEs, and non-transitory computer-readable medium described herein, receiving the cancellation message may include operations, features, means, or instructions for receiving the cancellation message via a CSS associated with the UE, where a scrambling sequence associated with the cancellation message may be based on a group RNTI or a UE identifier of the UE.

In some examples of the method, UEs, and non-transitory computer-readable medium described herein, the portion of the uplink message that may be canceled corresponds to a PCell for the UE and to one or more activated SCells associated with the UE.

In some examples of the method, UEs, and non-transitory computer-readable medium described herein, the PCell and the one or more activated SCells may be associated with a same PUCCH group, a same TAG, or both.

In some examples of the method, UEs, and non-transitory computer-readable medium described herein, receiving the cancellation message may include operations, features, means, or instructions for receiving an indication of a priority of the uplink message relative to one or more other uplink messages, where cancelling transmission of at least the portion of the uplink message may be based on the priority.

In some examples of the method, UEs, and non-transitory computer-readable medium described herein, receiving the cancellation message may include operations, features, means, or instructions for receiving a SLIV, a RIV, or both indicative of the portion of the uplink message that may be canceled.

In some examples of the method, UEs, and non-transitory computer-readable medium described herein, receiving the cancellation message may include operations, features, means, or instructions for receiving an indication of a bitmap indicating a set of time-frequency resources corresponding to the portion of the uplink message that may be canceled, where the set of time-frequency resources corresponds to both the first subband and the second subband.

In some examples of the method, UEs, and non-transitory computer-readable medium described herein, the bitmap includes a first value indicating that the first subband may be canceled for a duration of time and includes a second value indicating that the second subband may be not canceled for the duration of time.

In some examples of the method, UEs, and non-transitory computer-readable medium described herein, the cancellation message includes a first field indicating that both the first subband and the second subband may be at least partially canceled and a second field indicating both a first subset of time-frequency resources within the first subband and a second subset of time-frequency resources within the second subband that may be canceled.

In some examples of the method, UEs, and non-transitory computer-readable medium described herein, the uplink message may be at least one of an uplink control message or a random access message.

A method for wireless communications by a network entity is described. The method may include transmitting a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE and transmitting a preemption message indicating that at least a portion of the downlink message is preempted, the portion corresponding to the first subband and the second subband.

A network entity for wireless communications is described. The network entity may include one or more memories storing processor executable code, and one or more processors coupled with the one or more memories. The one or more processors may individually or collectively be operable to execute the code to cause the network entity to transmit a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE and transmit a preemption message indicating that at least a portion of the downlink message is preempted, the portion corresponding to the first subband and the second subband.

Another network entity for wireless communications is described. The network entity may include means for transmitting a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE and means for transmitting a preemption message indicating that at least a portion of the downlink message is preempted, the portion corresponding to the first subband and the second subband.

A non-transitory computer-readable medium storing code for wireless communications is described. The code may include instructions executable by one or more processors to transmit a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE and transmit a preemption message indicating that at least a portion of the downlink message is preempted, the portion corresponding to the first subband and the second subband.

In some examples of the method, network entities, and non-transitory computer-readable medium described herein, transmitting the preemption message may include operations, features, means, or instructions for transmitting the preemption message via a USS for the UE, where a scrambling sequence associated with the preemption message may be based on a UE identifier of the UE.

In some examples of the method, network entities, and non-transitory computer-readable medium described herein, transmitting the preemption message may include operations, features, means, or instructions for transmitting the preemption message via a CSS associated with the UE, where a scrambling sequence associated with the preemption message may be based on a group RNTI or a UE identifier of the UE.

In some examples of the method, network entities, and non-transitory computer-readable medium described herein, transmitting the preemption message may include operations, features, means, or instructions for transmitting an indication of whether the portion of the downlink message that may be preempted occurs before or after transmission of the preemption message and an indication of a time period corresponding to the portion of the downlink message that may be preempted.

In some examples of the method, network entities, and non-transitory computer-readable medium described herein, transmitting the preemption message may include operations, features, means, or instructions for transmitting an indication of a priority of the downlink message relative to one or more other downlink messages.

In some examples of the method, network entities, and non-transitory computer-readable medium described herein, transmitting the preemption message may include operations, features, means, or instructions for transmitting a SLIV, a RIV, or both indicative of the portion of the downlink message that may be preempted.

In some examples of the method, network entities, and non-transitory computer-readable medium described herein, transmitting the preemption message may include operations, features, means, or instructions for transmitting an indication of a bitmap indicating a set of time-frequency resources corresponding to the portion of the downlink message that may be preempted, where the set of time-frequency resources corresponds to both the first subband and the second subband.

A method for wireless communications by a network entity is described. The method may include transmitting a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE and transmitting a cancellation message indicating that at least a portion of the uplink message is canceled based on the scheduling information, the portion corresponding to the first subband and the second subband.

A network entity for wireless communications is described. The network entity may include one or more memories storing processor executable code, and one or more processors coupled with the one or more memories. The one or more processors may individually or collectively be operable to execute the code to cause the network entity to transmit a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE and transmit a cancellation message indicating that at least a portion of the uplink message is canceled based on the scheduling information, the portion corresponding to the first subband and the second subband.

Another network entity for wireless communications is described. The network entity may include means for transmitting a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE and means for transmitting a cancellation message indicating that at least a portion of the uplink message is canceled based on the scheduling information, the portion corresponding to the first subband and the second subband.

A non-transitory computer-readable medium storing code for wireless communications is described. The code may include instructions executable by one or more processors to transmit a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE and transmit a cancellation message indicating that at least a portion of the uplink message is canceled based on the scheduling information, the portion corresponding to the first subband and the second subband.

In some examples of the method, network entities, and non-transitory computer-readable medium described herein, transmitting the cancellation message may include operations, features, means, or instructions for transmitting the cancellation message via a USS for the UE, where a scrambling sequence associated with the cancellation message may be based on a UE identifier of the UE.

In some examples of the method, network entities, and non-transitory computer-readable medium described herein, transmitting the cancellation message may include operations, features, means, or instructions for transmitting the cancellation message via a CSS associated with the UE, where a scrambling sequence associated with the cancellation message may be based on a group RNTI or a UE identifier of the UE.

In some examples of the method, network entities, and non-transitory computer-readable medium described herein, transmitting the cancellation message may include operations, features, means, or instructions for transmitting an indication of a priority of the uplink message relative to one or more other uplink messages.

In some examples of the method, network entities, and non-transitory computer-readable medium described herein, transmitting the cancellation message may include operations, features, means, or instructions for transmitting a SLIV, a RIV, or both indicative of the portion of the uplink message that may be canceled.

In some examples of the method, network entities, and non-transitory computer-readable medium described herein, transmitting the cancellation message may include operations, features, means, or instructions for transmitting an indication of a bitmap indicating a set of time-frequency resources corresponding to the portion of the uplink message that may be canceled, where the set of time-frequency resources corresponds to both the first subband and the second subband.

### BRIEF DESCRIPTION OF THE DRAWINGS

FIG. 1 shows an example of a wireless communications system that supports enhancements of downlink preemption indication (DLPI) and uplink cancelation indication (ULCI) in accordance with one or more aspects of the present disclosure.

FIG. 2 shows an example of a wireless communications system that supports enhancements of DLPI and ULCI in accordance with one or more aspects of the present disclosure.

FIGS. 3A and 3B show examples of signaling diagrams that support enhancements of DLPI and ULCI in accordance with one or more aspects of the present disclosure.

FIG. 4 shows an example of a signaling diagram that supports enhancements of DLPI and ULCI in accordance with one or more aspects of the present disclosure.

FIG. 5 shows an example of a signaling diagram that supports enhancements of DLPI and ULCI in accordance with one or more aspects of the present disclosure.

FIG. 6 shows an example of a signaling diagram that supports enhancements of DLPI and ULCI in accordance with one or more aspects of the present disclosure.

FIG. 7 shows an example of a process flow that supports enhancements of DLPI and ULCI in accordance with one or more aspects of the present disclosure.

FIG. 8 shows an example of a process flow that supports enhancements of DLPI and ULCI in accordance with one or more aspects of the present disclosure.

FIGS. 9 and 10 show block diagrams of devices that support enhancements of DLPI and ULCI in accordance with one or more aspects of the present disclosure.

FIG. 11 shows a block diagram of a communications manager that supports enhancements of DLPI and ULCI in accordance with one or more aspects of the present disclosure.

FIG. 12 shows a diagram of a system including a device that supports enhancements of DLPI and ULCI in accordance with one or more aspects of the present disclosure.

FIGS. 13 and 14 show block diagrams of devices that support enhancements of DLPI and ULCI in accordance with one or more aspects of the present disclosure.

FIG. 15 shows a block diagram of a communications manager that supports enhancements of DLPI and ULCI in accordance with one or more aspects of the present disclosure.

FIG. 16 shows a diagram of a system including a device that supports enhancements of DLPI and ULCI in accordance with one or more aspects of the present disclosure.

FIGS. 17 and 18 show flowcharts illustrating methods that support enhancements of DLPI and ULCI in accordance with one or more aspects of the present disclosure.

### DETAILED DESCRIPTION

In some wireless communications systems, a network entity may transmit, to a user equipment (UE), a downlink preemption indication (DLPI) message, indicating that at least a subset of resources of a previously transmitted downlink message are preempted, or an uplink cancelation indication (ULCI) message, indicating that at least a subset of resources of a scheduled uplink message at the UE are canceled. In some wireless communications systems (e.g., 5^{th} generation (5G) systems, 6^{th} generation (6G) systems, or beyond), a network entity may communicate with the UE via a virtual cell over non-contiguous sub-bands. The virtual cell may be formed by fractional spectrum integration. For example, the virtual cell may include multiple subbands which may be separated relative to one another by one or more frequency gaps. In some examples, the multiple subbands of the virtual cell may be associated with respective cells of a network entity. In some cases, the UE may configured to transmit or receive messages via the virtual cell, and different portions of the message may be communicated over the non-contiguous subbands simultaneously. In some examples, the non-contiguous subbands of the virtual cell may each correspond to a respective radio frequency spectrum band (e.g., frequency range 3 (FR3), frequency range 4 (FR4), frequency range 5 (FR5), etc.). However, current signaling mechanisms for DLPI and ULCI may not support preemption or cancelation of transmissions (e.g., downlink transmissions, uplink transmissions) that span multiple non-contiguous subbands.

In accordance with examples described herein, a UE may support signaling of a DLPI and a ULCI that indicates preemption or cancelation of downlink and uplink transmissions that span multiple non-contiguous subbands (e.g., of a virtual cell associated with a network entity). In some examples, the signaling of the DLPI and the ULCI may support indication of DLPI and ULCI that applies to (e.g., spans) multiple component carriers of a carrier aggregation configuration (e.g., of a physical uplink control channel (PUCCH) group or of a timing advance group (TAG)). In some examples, the network entity may schedule the UE with a downlink or uplink transmission that is transmitted via multiple non-contiguous subbands of a virtual cell, and the network entity may preempt portions of the downlink message via the DLPI or may cancel portions of the uplink message via the ULCI. In some examples, the DLPI or the ULCI may include one or bitmaps to indicate which of the multiple non-contiguous subbands are preempted or canceled, which time or frequency resources within the subbands are preempted or canceled, or both. In some examples, the ULCI may include a direction of cancellation that indicates whether the ULCI is canceling a transmission that occurs before or after the ULCI.

Aspects of the disclosure are initially described in the context of wireless communications systems. Aspects of the disclosure are further described in the context of wireless communications systems, signaling diagrams, and process flows. Aspects of the disclosure are further illustrated by and described with reference to apparatus diagrams, system diagrams, and flowcharts that relate to enhancements of DLPI and ULCI.

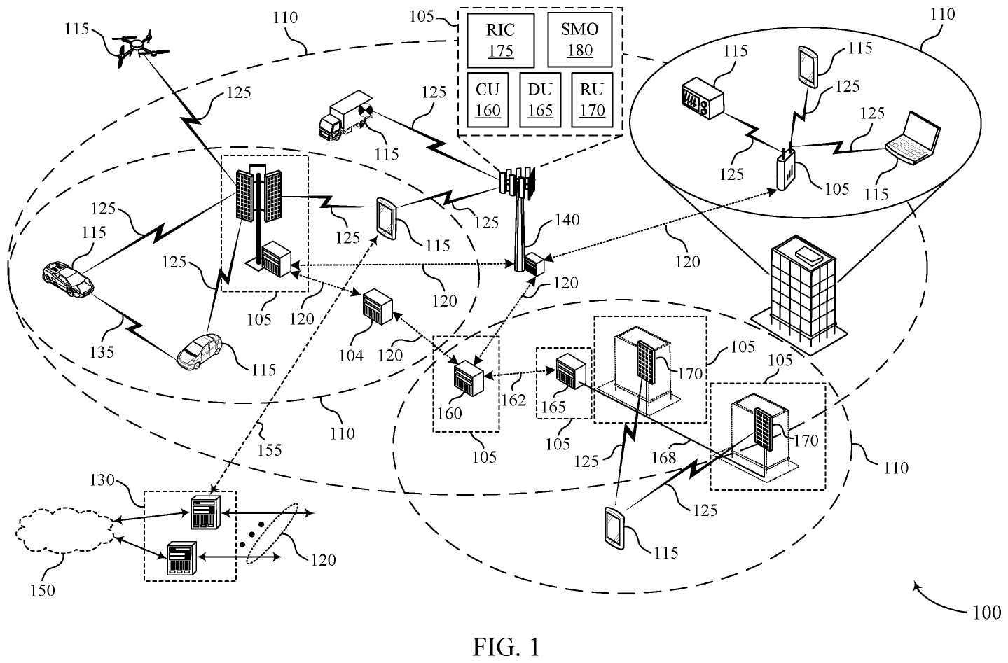

FIG. 1 shows an example of a wireless communications system 100 that supports enhancements of DLPI and ULCI in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space (CSS) sets configured for sending control information to UEs 115 (e.g., one or more UEs) or may include UE-specific search space (USS) sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 may receive, from a network entity 105, a control message indicating scheduling information for a downlink message that is scheduled for transmission via a first subband of a first radio frequency spectrum band and via a second subband of a second radio frequency spectrum band different from the first radio frequency spectrum band. The second subband may be non-contiguous with the first subband, and the first and second subbands may be associated with a virtual cell that supports communications for the UE 115. The UE 115 may monitor the first subband and the second subband for the downlink message from the virtual cell based on the scheduling information. The UE 115 may receive a preemption message indicating that at least a portion of the downlink message is preempted, and the portion may correspond to the first subband and the second subband.

In some other examples, the UE 115 may receive, from a network entity 105, a control message indicating scheduling information for an uplink message that is scheduled for transmission via a first subband of a first radio frequency spectrum band and via a second subband of a second radio frequency spectrum band different from the first radio frequency spectrum band. The second subband may be non-contiguous with the first subband, and the first and second subbands may be associated with a virtual cell that supports communications for the UE 115. The UE 115 may receive a cancellation message indicating that at least a portion of the downlink message is canceled, and the portion may correspond to the first subband and the second subband. The UE 115 may cancel transmission of at least the portion of the uplink message based on the cancellation message.

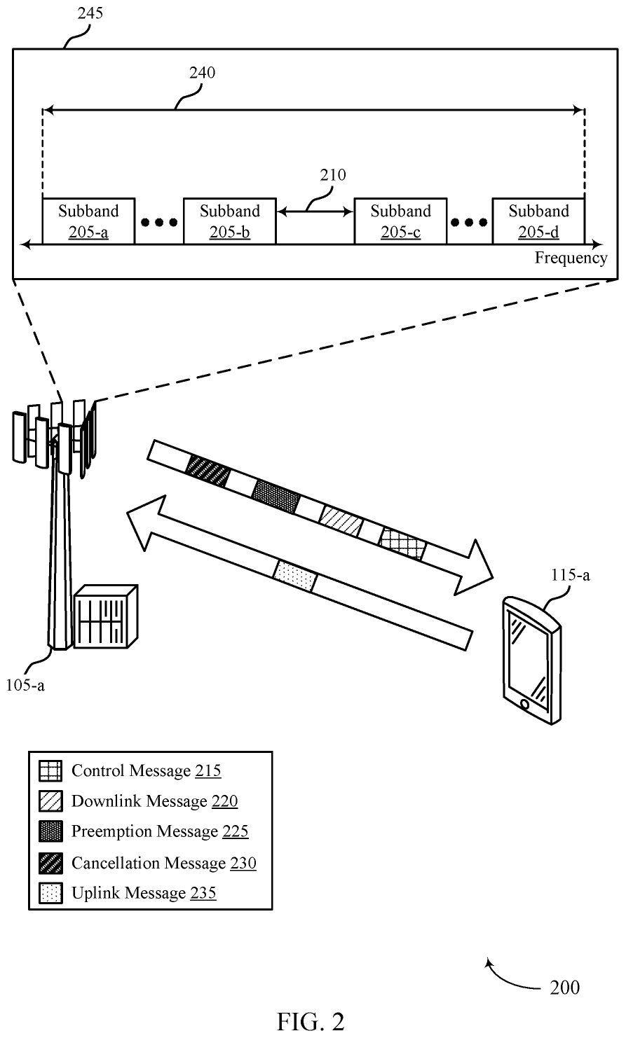

FIG. 2 shows an example of a wireless communications system 200 that supports enhancements of DLPI and ULCI in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding devices described herein.

A network entity 105-a may transmit a control message 215 (e.g., a downlink control information (DCI) message) to a UE 115-a that schedules one or more uplink messages (e.g., via a physical uplink shared channel (PUSCH), via a PUCCH), one or more downlink messages (e.g., via a physical downlink shared channel (PDSCH), via a physical downlink control channel (PDCCH), or both). In some examples, the UE 115-a may monitor for the control message 215, and the control message 215 may schedule uplink messages or downlink messages to be communicated (e.g., transmitted, received) over multiple cells of the network entity 105-a. The control message may be associated with a DCI format (e.g., format 0, format 1A/1B, format 2). The multi-cell DCI may increase flexibility and spectral efficiency or power efficiency by utilizing simultaneous data scheduling over multiple cells.

In some examples, the multi-cell DCI message may co-schedule a combination of cells from a set of cells (e.g., Cell-1, Cell-2, Cell-3, Cell-4) that the network entity 105-a may support for co-scheduling. For example, the multi-cell DCI message may indicate a co-scheduled cell indicator (CCI), and CCI may indicate one or more cells of the set of cells via which downlink messages or uplink messages are scheduled. In some examples, the CCI may indicate a pair of cells. A payload size for the control message 215 may correspond to a first combination of cells, from a set of candidate combinations of the cells, that results in the largest payload size. For example, a first value of the CCI may indicate a combination of Cell-1 and Cell2, a second value of the CCI may indicate a combination of Cell-3 and Cell-4, a third value of the CCI may indicate a combination of Cell-1 and Cell-3, and a fourth value of the CCI may indicate a combination of Cell-2 and Cell-4. The network entity 105-a may determine a respective payload size of each combination of cells, and a payload of the control message 215 may be the largest of the respective payload sizes (e.g., such that a payload size of the control message 215 may be sufficient for any of the candidate combinations of cells). Alternatively, in cases where the combinations of co-scheduled cells are not configured, the payload size of the control message 215 may be based on a sum of the cells in the set (e.g., regardless of which combinations of cells are co-scheduled).

In some cases, a cell of the network entity 105-a may be a virtual cell 245. The virtual cell 245 may be formed by fractional spectrum integration. For example, the virtual cell 245 may include multiple subbands 205 (e.g., a subband 205-a, a subband 205-b, a subband 205-c, a subband 205-d). The subbands 205 may be separated respective to one another by a frequency gap 210 (e.g., a frequency gap 210 between the subband 205-b and the subband 205-c). An aggregated bandwidth 240 of the virtual cell 245 may be a set of frequencies that spans the subbands 205 (e.g., from the subband 205-a to the subband 205-d). In some examples, thresholds on the frequency gap 210, a round trip delay, or an average reception power difference associated with the virtual cell 245 may be configured to comply with existing configurations (e.g., for homogenous, non-virtual cells) of numerology, waveform, timing advance, source reference signal for L1 or L2 measurements, quasi-colocation relationships, or a combination thereof. In some examples, the multiple subbands 205 associated with the virtual cell 245 may each correspond to respective radio frequency spectrum bands. The radio frequency spectrum bands may include frequency range 1 (FR1), frequency range 2 (FR2), FR3, FR4, FR5, frequency range 6 (FR6), among other frequency ranges. In an example, the subband 205-a may correspond to FR2, the subband 205-b may correspond to FR3, the subband 205-c may correspond to FR4, and the subband 205-d may correspond to FR5.

To support reliability enhancement and latency reduction of some wireless communications (e.g., eMBB, URLLC), the network entity 105-a may transmit a preemption message 225, which may be a DLPI that preempts one or more downlink messages previously transmitted by the network entity 105-a. Additionally, or alternatively, the network entity 105-a may transmit a cancellation message 230, which may be a ULCI that cancels one or more uplink messages scheduled to be transmitted by the UE 115-a. In some examples, it may be beneficial to preempt or cancel messages that are scheduled to be communicated (e.g., simultaneously) over multiple cells. Such messages may be scheduled by the network entity 105-a via a multi-cell DCI message. However, signaling of the preemption message 225 and the cancellation message 230 by the network entity 105-a may not support preemption or cancellation of multi-cell DCI scheduling.

In some examples, the UE 115-a may be configured to communicate with the network entity 105-a via the virtual cell 245 that includes non-contiguous subbands 205, or via multiple component carriers of a carrier aggregation configuration, for communication of the downlink message 220, the uplink message 235, or both. For example, the UE 115-a may receive a control message (e.g., DCI) indicating scheduling information for a downlink message or an uplink message that is scheduled for transmission via a first subband of a first radio frequency spectrum band and via a second subband of a second radio frequency spectrum band. The first subband and the second subband may be non-contiguous bands associated with the virtual cell 245. In some cases, the UE 115-a may yield to other UEs of relatively higher priority or to other service types of relatively higher priority. In some examples, the control message 215 may include a common indication for scheduling over multiple subbands or component carriers, and a payload size of the control message 215 may be reduced relative to payload sizes of other DCI (e.g., that include separate indications for scheduling over each respective subband or component carrier of a set of subbands or component carriers).

In accordance with examples described herein, the UE 115-a and the network entity 105-a may support enhancements to signaling mechanisms for DLPI and ULCI to support preemption and cancellation of messages that are scheduled over the virtual cell 245 (e.g., fractional spectrum integration) or over multiple carriers of a carrier aggregation. Such preemption and cancellation signaling enhancements may support increased scheduling flexibility, power efficiency, spectral efficiency, and quality of service diversity.

In some examples, the UE 115-a may be configured with the virtual cell 245 or downlink or uplink carrier aggregation, and the preemption message 225 or the cancellation message 230 may be transmitted in a USS set or a CSS set (e.g., unicast, group cast, broadcast) of the UE 115-a in an active downlink bandwidth part of the scheduling cell, and the DLPI or the ULCI may apply to multiple sub-bands of a virtual cell, or multiple component carriers of a carrier aggregation. In cases of the preemption message 225 or the cancellation message 230 being transmitted in the USS, a cyclic redundancy check (CRC) (e.g., a scrambling sequence) of the DCI may be scrambled by a UE identifier (e.g., a cell radio network temporary identifier (C-RNTI)). In other cases of the preemption message 225 or the cancellation message 230 being transmitted in the CSS, the CRC of the DCI may be scrambled either by a group radio network temporary identifier (RNTI) (e.g., interruption RNTI (INT-RNTI), cancellation indication RNTI (CI-RNTI)) or by the UE identifier.

In some examples, the UE 115-a may be configured for communication over the virtual cell 245, and a resource indication (e.g., of resources to preempt/cancel) indicated by the DLPI or ULCI may include non-continuous subbands of an active downlink or uplink bandwidth part. In some other examples, the UE 115-a may be configured for downlink carrier aggregation, and a resource indication (e.g., of resources to preempt) indicated by the DLPI may include a primary cell (PCell) and one or more activated secondary cells (SCells) belonging to a same PUCCH group. Additionally, or alternatively, the UE 115-a may be configured for uplink carrier aggregation, and a resource indication (e.g., of resources to cancel) indicated by the ULCI may include a PCell and one or more activated SCells belonging to a same TAG.

In some implementations, a payload size of the preemption message 225, the cancellation message 230, or both, may be configured by higher layers. For example, the payload size may be based on threshold quantity of subbands 205 configured for an active downlink or uplink bandwidth part on the virtual cell 245, or a threshold quantity of active SCells configured for a PUCCH group, in downlink carrier aggregation configurations, or a threshold quantity of active SCells configured for a TAG, in uplink carrier aggregation configurations.

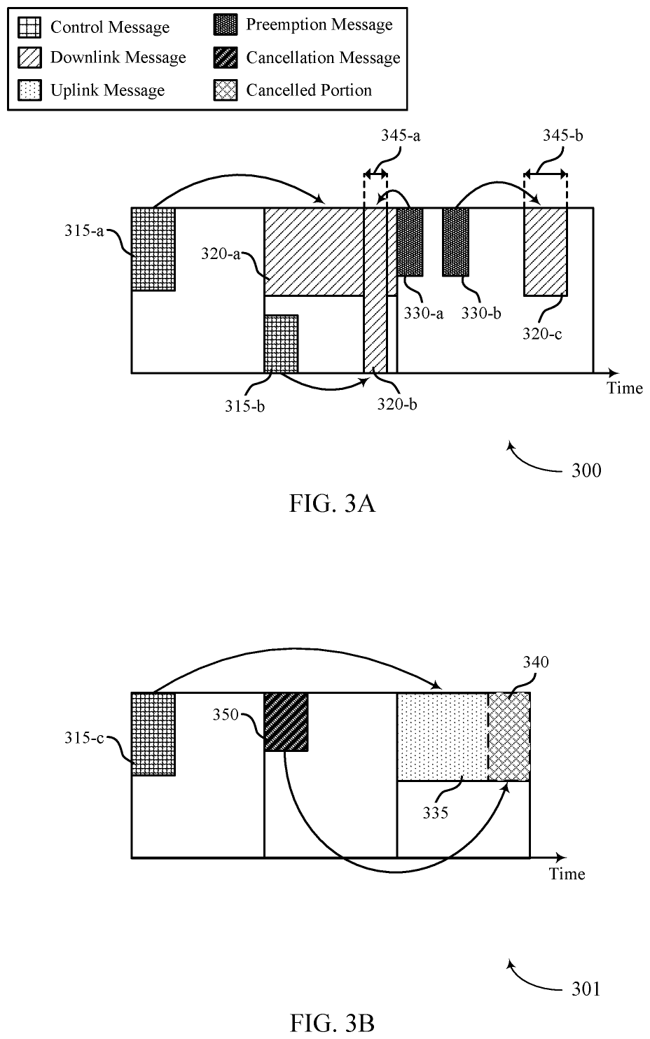

FIGS. 3A and 3B show examples of signaling diagrams 300 and 301 that support enhancements of DLPI and ULCI in accordance with one or more aspects of the present disclosure. The signaling diagrams 300 and 301 may implement or may be implemented by aspects of the wireless communications system 100 and the wireless communications system 200. For example, the signaling diagrams 300 and 301 may include examples of signaling between a UE 115-a and a network entity 105-a, as described with reference to FIG. 2.

In FIG. 3A, a control message 315-a (e.g., a DCI) transmitted by a network entity may schedule a downlink message 320-a. The downlink message 320-a may be of a first service type (e.g., eMBB). Similarly, a control message 315-b may schedule a downlink message 320-b of a second service type (e.g., URLLC). In some examples, the downlink message 320-b may partially (or fully) overlap, in frequency or time (e.g., in a same set of frequency resources, in a same slot), with the downlink message 320-a. The network entity may transmit a preemption message 330-a (e.g., a DLPI) to a UE to preempt the downlink message 320-b. The DLPI may indicate that data communicated via the downlink message 320-b is invalid.

In some examples, the preemption message 330 may include a field indicating a direction of cancellation, which may indicate whether the network entity 105-a is preempting downlink messages 320 (e.g., control messages, data messages) scheduled after or before the end of a slot that the UE 115-a receives the DLPI. For example, the UE may receive an indication (e.g., direction of cancellation indication) of whether the portion of the downlink message 320 that is preempted occurs before or after reception of the preemption message 330 and an indication of a time period 345 corresponding to the portion of the downlink message that is preempted. In an example, a preemption message 330-a may include a direction of cancellation field that is a first value (e.g., 0) to indicate that downlink messages (e.g., downlink unicast or multicast data or control messages) scheduled in a time period 345-a prior to reception of the preemption message 330-a by the UE are canceled or preempted. For example, the preemption message 330-a may indicate that the downlink message 320-b scheduled or transmitted within the time period 345-a is preempted. The time period 345-a may correspond to a time period between slot n−k1 and slot n−k2, where n may be the slot index at which the UE receives the DLPI, and where k1≥k2>0. A threshold (e.g., maximum) value of k1, or a threshold (e.g., maximum) duration of the time period 345-a (e.g., k1−k2+1), or both may be based on UE capability, a frequency range, a quantity of activated downlink component carriers or subbands configured for the active downlink bandwidth part, a duplex mode (e.g., of the UE), or a combination thereof.

In another example, a preemption message 330-b may include a direction of cancellation field that is a second value (e.g., 1) to indicate that downlink messages (e.g., downlink unicast or multicast data or control messages) scheduled in a time period 345-b after reception of the preemption message 330-b by the UE are canceled or preempted. For example, the preemption message 330-b may indicate that the downlink message 320-c scheduled within the time period 345-b is preempted. The time period 345-b may correspond to a time period between slot n+k3 and slot n+k4, where n may be the slot index at which the UE receives the DLPI, and where k4≥k3>0. A threshold (e.g., minimum) value of k3, or a threshold (e.g., maximum) duration of the time period 345-b (e.g., k4−k3+1), or both may be based on UE capability, a frequency range, a quantity of activated downlink component carriers or subbands configured for the active downlink bandwidth part, a duplex mode (e.g., of the UE), or a combination thereof.

In some examples, a preemption message 330 (e.g., a DLPI) may include a priority indicator. The priority indicator may indicate that a subset of downlink messages 320 (e.g., service types of downlink messages 320) are relatively high priority (e.g., satisfying a threshold priority) and are not to be canceled. For example, the priority indicator may indicate that broadcast signals including a cell-defining synchronization signal block (CD-SSB), a system information block Type 1 (SIB1), other system information (OSI), paging messages, or physical random access channel (PRACH) messages (e.g., msg2, msgB, random access response (RAR)) are not to be canceled. In some examples, the UE may refrain from cancelling one or more downlink messages 320 that may otherwise be canceled by the DLPI based on a priority of the one or more downlink messages satisfying a threshold. In some implementations, a configuration of priority indicators may be based on a subband of a virtual cell, a bandwidth part of an activated bandwidth, a component carrier of a set of component carriers of a carrier aggregation, or a combination thereof. For example, some subbands of the virtual cell may correspond to a relatively higher priority than other subbands of the virtual cell, some bandwidth parts may correspond to a relatively higher priority than other bandwidth parts of the virtual cell, or some component carriers may be associated with a relatively higher priority than other component carriers of the carrier aggregation.

In FIG. 3B, a control message 315-c (e.g., a DCI) transmitted by a network entity may schedule an uplink message 335. The uplink message 335 may be of a first service type (e.g., eMBB). The network entity may (e.g., prior to transmission of the uplink message 335) transmit a cancellation message 350 (e.g., a ULCI) to a UE to cancel at least a canceled portion 340 of the uplink message 335. The ULCI may indicate that the canceled portion 340 will not be transmitted by the network entity.

In some examples, ULCI may cancel one or more sounding reference signals (SRS) or one or more PUSCH transmissions. Additionally, or alternatively, the ULCI may cancel one or more PUCCH transmissions (e.g., including repetitions) or one or more PRACH transmissions (e.g., including repetitions) scheduled by the control message 315-c.

In some examples, a cancellation message 350 (e.g., a ULCI) may include a priority indicator. The priority indicator may indicate that a subset of uplink messages 335 (e.g., service types of uplink messages 335) are relatively high priority (e.g., satisfying a threshold priority) and are not to be canceled. In some examples, the priority indicator may indicate a priority corresponding to uplink control information (UCI), random access, PUSCH transmissions, SRS, or a combination thereof. In some cases, the priority indicator may indicate that PRACH transmissions associated with beam failure reporting or handover are not to be canceled. In some cases, the priority indicator may indicate that PUCCH transmissions carrying HARQ ACK or NACK or scheduling requests are not to be canceled. In some examples, the UE may refrain from cancelling one or more uplink messages 335 that may otherwise be canceled by the ULCI based on a priority of the one or more uplink messages 335 satisfying a threshold. In some implementations, a priority indicator indicated by the ULCI may be based on, or may apply to, a subband of a virtual cell, a bandwidth part of an activated bandwidth, a component carrier of a set of component carriers of a carrier aggregation, or a combination thereof. For example, some subbands of the virtual cell may correspond to a relatively higher priority than other subbands of the virtual cell, some bandwidth parts may correspond to a relatively higher priority than other bandwidth parts of the bandwidth of the virtual cell, or some component carriers may be associated with a relatively higher priority than other component carriers of the carrier aggregation. A quantity of bits within the ULCI used to signal the priority indicator may be configured via RRC signaling (e.g., from the network entity).

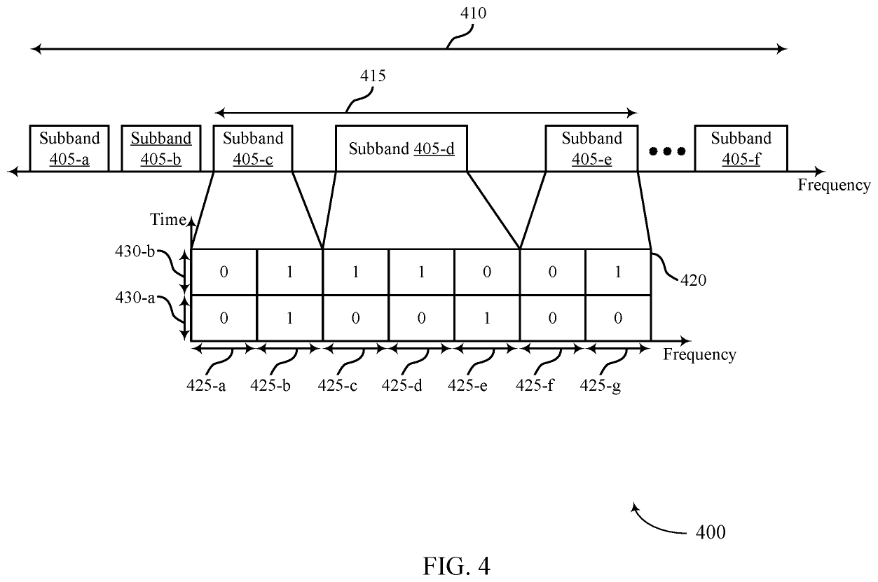

FIG. 4 shows an example of a signaling diagram 400 that supports enhancements of DLPI and ULCI in accordance with one or more aspects of the present disclosure. The signaling diagram 400 may implement or may be implemented by aspects of the wireless communications system 100, the wireless communications system 200, and the signaling diagram 300. For example, the signaling diagram 400 may include examples of signaling to be included in a preemption message 225 or a cancellation message 230, as described with reference to FIG. 2.

A preemption message or a cancellation message transmitted by a network entity to a UE may indicate a set of resources (e.g., time or frequency resources) for which preemption or cancellation of downlink or uplink transmissions applies. For example, the preemption message or the cancellation message may indicate a subset of resources within an active bandwidth part 415 of a bandwidth 410. The bandwidth 410 may be a bandwidth of a virtual cell configured for wireless communications with the UE. In some examples, the network entity may indicate that some subbands of the bandwidth 410 (e.g., subband 405-c, subband 405-d, and subband 405-e) are active and that other subbands of the bandwidth 410 (e.g., subband 405-a, subband 405-b, subband 405-f, other subbands 405) are inactive.

In some examples, the time or frequency resources preempted or canceled on the active bandwidth part 415 may be indicated via a start and length indicator value (SLIV) or a resource indicator value (RIV). The indications of SLIV and RIV may be common to each subband within the active bandwidth part 415 that may be eligible for DLPI or ULCI. Alternatively, the indication of SLIV and RIV may be sub-band specific, and different SLIVs or RIVs may be indicated for different subbands (e.g., a first SLIV or RIV applying to the subband 405-c, a second SLIV or RIV applying to the subband 405-d, and a third SLIV or RIV applying to the subband 405-e).

In some other examples, the time or frequency resources preempted or canceled on the active bandwidth part 415 may be indicated via a single bitmap 420 that applies across each subband (e.g., the subband 405-c, the subband 405-d, and the subband 405-e) of the active bandwidth part 415. For example, the preemption message or the cancellation message may include an indication of the bitmap 420 that indicates a set of time-frequency resources corresponding to a portion of a downlink message (e.g., or portions of multiple downlink messages) that is preempted or a portion of an uplink message (e.g., or portions of multiple uplink messages) that is canceled, and the set of time-frequency resources may correspond to (e.g., may include at least portions of) the subband 405-c, the subband 405-d, and the subband 405-e. A first value (e.g., 1) of a bit in the bitmap 420 may indicate that the time or frequency block corresponding to the bit is preempted or canceled, and a second value (e.g., 0) of a bit in the bitmap 420 may indicate that the time or frequency block corresponding to the bit is not preempted or canceled. In an example, a frequency block 425-a and a time block 430-b may not be preempted or canceled while a frequency block 425-b and the time block 430-b may be preempted or canceled.

A size of the bitmap 420 may be equal to a number of frequency blocks 425 of the active BWP multiplied with the number of time blocks 430, where the number of frequency blocks of the active BWP is a sum of the frequency blocks 425 in the activated sub-bands (e.g., the subband 405-c, the subband 405-d, and the subband 405-e) of the active bandwidth part 415, or a sum of frequency blocks in the activated CCs of a PUCCH group or TAG (e.g., in accordance with carrier aggregation). For example, the bitmap 420 may include indications for a frequency block 425-a and a frequency block 425-b, which may be included the subband 405-c, a frequency block 425-c, a frequency block 425-d, and a frequency block 425-e, which may be included in the subband 405-d, and a frequency block 425-f and a frequency block 425-g, which may be included in the subband 405-e. The size of the bitmap 420, a granularity (e.g., unit) of frequency blocks 425 within the bitmap 420, a granularity (e.g., unit) of time blocks 430 within the bitmap 420, or a combination thereof, may be configured by RRC signaling. In some examples, the bitmap may include indications for a time block 430-a and a time block 430-b, and a unit of a time block may be a symbol, a sub-slot, a slot, a subframe, or any other division of time.

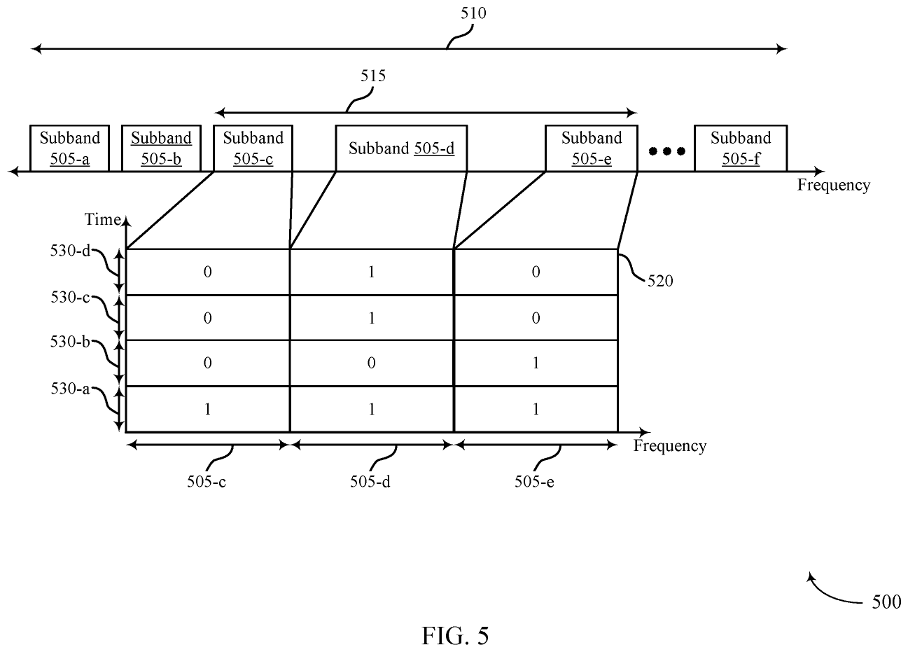

FIG. 5 shows an example of a signaling diagram 500 that supports enhancements of DLPI and ULCI in accordance with one or more aspects of the present disclosure. The signaling diagram 500 may implement or may be implemented by aspects of the wireless communications system 100, the wireless communications system 200, and the signaling diagram 300. For example, the signaling diagram 500 may include examples of signaling to be included in a preemption message 225 or a cancellation message 230, as described with reference to FIG. 2.

A preemption message or a cancellation message transmitted by a network entity to a UE may indicate a set of resources (e.g., time or frequency resources) for which preemption or cancellation of downlink or uplink transmissions applies. For example, the preemption message or the cancellation message may indicate a subset of resources within an active bandwidth part 515 of a bandwidth 510. The bandwidth 510 may be a bandwidth of a virtual cell configured for wireless communications with the UE. In some examples, the network entity may indicate that some subbands of the bandwidth 510 (e.g., subband 505-c, subband 505-d, and subband 505-e) are active and that other subbands of the bandwidth 510 (e.g., subband 505-a, subband 505-b, subband 505-f, other subbands 505) are inactive.

In some examples, the time or frequency resources preempted or canceled on the active bandwidth part 515 may be indicated via a bitmap 520 which may indicate whether subbands 505 (e.g., a frequency range spanning the entire subband 505) are preempted or canceled in one or more time blocks 530 (e.g., a time block 530-a, a time block 530-b, a time block 530-c, a time block 530-d). In an example, the bitmap 520 may include a first value (e.g., 1) corresponding to the subband 505-c and the time block 530-a to indicate that the subband 505-c is preempted or canceled for the time block 530-d (e.g., a duration) and may include a second value (e.g., 0) corresponding to the subband 505-c and the time block 530-d to indicate that the subband 505-c is not preempted or canceled for the time block 530-a. For the same time block 530-d, the bitmap 520 may indicate that the subband 505-c and the subband 505-e are not preempted or canceled while the subband 505-d is preempted or canceled. For example, the bitmap may include a first value (e.g., 1) indicating that the subband 505-d is preempted for a duration of time (e.g., the time block 530-d) and may include a second value (e.g., 0) indicating that the subband 505-c is not preempted for the duration of time.

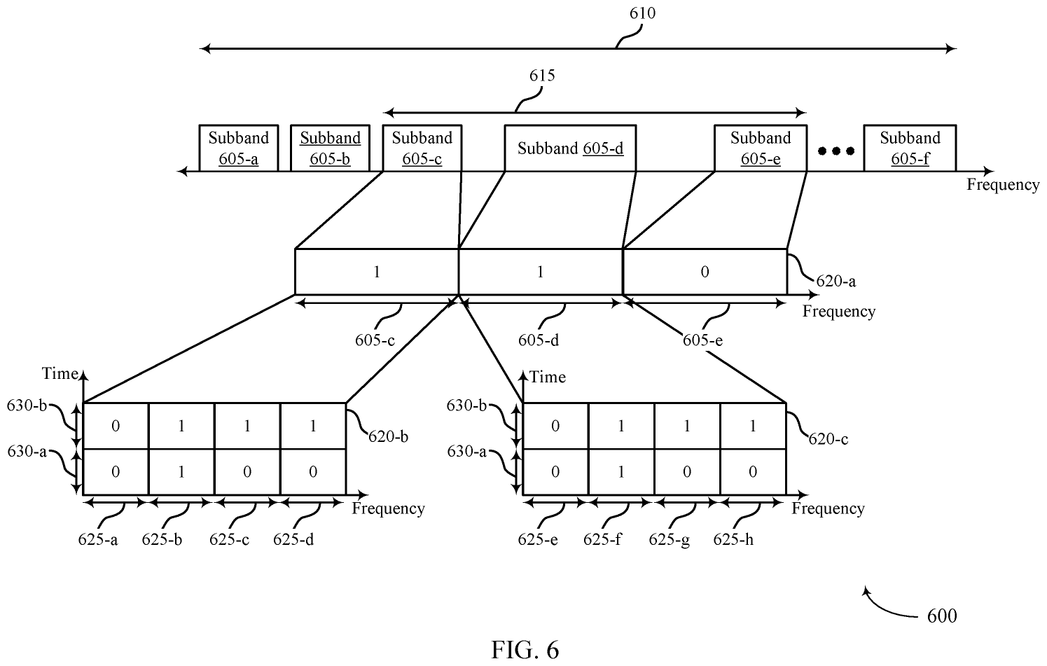

FIG. 6 shows an example of a signaling diagram 600 that supports enhancements of DLPI and ULCI in accordance with one or more aspects of the present disclosure. The signaling diagram 600 may implement or may be implemented by aspects of the wireless communications system 100, the wireless communications system 200, and the signaling diagram 300. For example, the signaling diagram 600 may include examples of signaling to be included in a preemption message 225 or a cancellation message 230, as described with reference to FIG. 2.

A preemption message or a cancellation message transmitted by a network entity to a UE may indicate a set of resources (e.g., time or frequency resources) for which preemption or cancellation of downlink or uplink transmissions applies. For example, the preemption message or the cancellation message may indicate a subset of resources within an active bandwidth part 615 of a bandwidth 610. The bandwidth 610 may be a bandwidth of a virtual cell configured for wireless communications with the UE. In some examples, the network entity may indicate that some subbands of the bandwidth 610 (e.g., subband 605-c, subband 605-d, and subband 605-e) are active and that other subbands of the bandwidth 610 (e.g., subband 605-a, subband 605-b, subband 605-f, other subbands 605) are inactive.

In some examples, the time or frequency resources preempted or canceled on the active bandwidth part 615 may be indicated via multiple bitmaps 620. A first bitmap 620-a may indicate a preemption or cancellation status of the subbands 605 within the active bandwidth part 615, and other bitmaps (e.g., the bitmap 620-b, the bitmap 620-c) may indicate time or frequency resources within each of the preempted or canceled subbands 605 that are preempted or canceled (e.g., subband specific preemption or cancellation patterns). For example, the preemption message or the cancellation message may include a first field (e.g., the bitmap 620-a) indicating that both the subband 605-c and the subband 605-d are at least partially preempted and may include a second field (e.g., the bitmap 620-b, the bitmap 620-c, or both) indicating that both a first subset of time-frequency resources (e.g., frequency block 625-b and time block 630-a) within the subband 605-c and a second subset of time-frequency resources (e.g., frequency block 625-f and time block 630-a) within the subband 605-d are preempted or canceled.

The bitmap 620-a may indicate the preemption or cancellation status of the subbands 605. That is, a first value (e.g., 1) may indicate that at least a portion of the time or frequency resources within the corresponding subband are preempted or canceled, and a second value (e.g., 0) may indicate that time or frequency resources of the corresponding subband are reserved (e.g., not preempted or canceled) or that no instances of preemption or cancellation occur within the time or frequency resources of the corresponding subband (e.g., the time or frequency resources are ineligible for preemption or cancellation). For example, the bitmap 620-a may indicate that the subband 605-c and the subband 605-d are at least partially preempted and that the subband 605-e is not preempted or canceled.

The bitmap 620-b may indicate which frequency blocks 625 (e.g., frequency block 625-a, frequency block 625-b, frequency block 625-c, frequency block 625-d) and which time blocks 630 (e.g., time block 630-a, time block 630-b) within the subband 605-c are canceled or preempted. Similarly, the bitmap 620-c may indicate which frequency blocks 625 (e.g., frequency block 625-e, frequency block 625-f, frequency block 625-g, frequency block 625-h) and which time blocks 630 (e.g., time block 630-a, time block 630-b) within the subband 605-d are canceled or preempted.

In some examples, the time or frequency resources preempted or canceled on the active bandwidth part 615 may be indicated by grouping subbands 605 with common preemption or cancellation resource patterns into a group and indicating the group common preemption or cancellation resource pattern with a bitmap that applies to each of the subbands 605 of the group. In such examples, a first field may indicate indices of co-indicated subbands 605 (e.g., subbands 605 to be grouped together). For example, each codepoint (e.g., value) of the first field may indicate a combination of one or more subbands 605 for which a group common preemption or cancellation resource pattern applies. A second field may indicate the group common preemption or cancellation resource pattern via one or multiple bitmaps that indicate time or frequency resources (e.g., per-frequency-block and per-time-block) that are preempted or canceled (e.g., reclaimed by the network entity) for the subbands 605 identified by the first field.

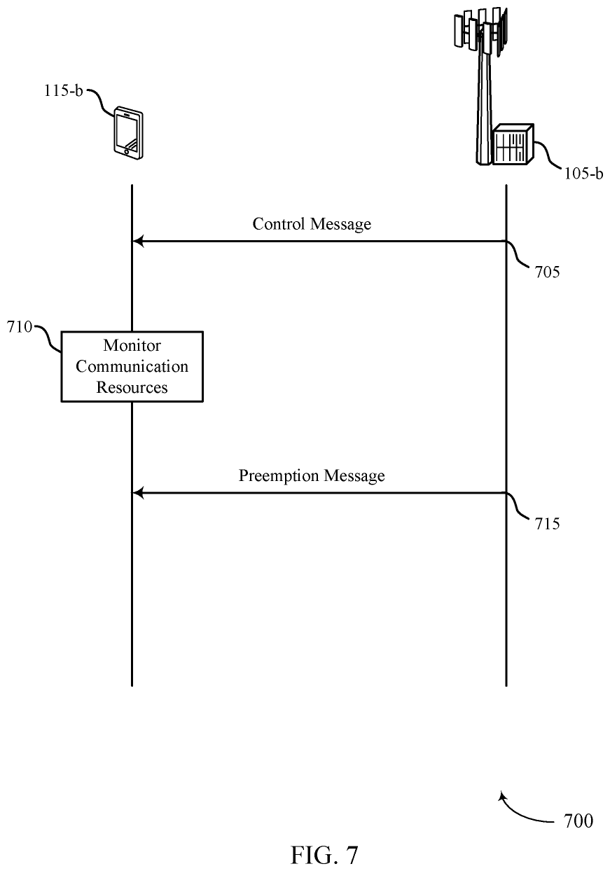

FIG. 7 shows an example of a process flow 700 that supports enhancements of DLPI and ULCI in accordance with one or more aspects of the present disclosure. The process flow 700 may implement or may be implemented by aspects of the wireless communications system 100, the wireless communications system 200, or the signaling diagram 300. For example, the process flow 700 may include a UE 115-b and a network entity 105-b, which may be examples of corresponding devices described herein.

In the following description of process flow 700, the operations may be performed in a different order than the order shown, or other operations may be added or removed from the process flow 700. For example, some operations may also be left out of process flow 700, may be performed in different orders or at different times, or other operations may be added to process flow 700. Although communications of the process flow 700 are shown occurring between a UE 115-b and a network entity 105-b, some aspects of some operations may also be performed by one or more other wireless devices, network devices, or network functions.

At 705, the UE 115-b may receive a control message (e.g., DCI) indicating scheduling information for a downlink message that is scheduled for transmission via a first subband of a first radio frequency spectrum band and via a second subband of a second radio frequency spectrum band that is different from the first radio frequency spectrum band. The second subband may be non-contiguous with the first subband. In some examples, the first subband and the second subband may be associated with a virtual cell (e.g., of the network entity 105-b) that supports communications for the UE 115-b. Additionally, or alternatively, the control message may indicate scheduling information for a downlink message that is scheduled for transmission via a first component carrier of a PUCCH group (e.g., of a downlink carrier aggregation configuration) and via a second component carrier of the PUCCH group.

At 710, the UE 115-b may monitor the first subband and the second subband for the downlink message from the virtual cell based on the scheduling information. In some examples, the UE 115-b may monitor the first subband and the second subband for one or more time blocks (e.g., one or more symbols, sub-slots, slots, subframes). Additionally, or alternatively, the UE 115-b may monitor the first component carrier and the second component carrier for the downlink message in accordance with a carrier aggregation indication or configuration for scheduling of the downlink message.

At 715, the UE 115-b may receive a preemption message (e.g., DCI, DLPI) indicating that at least a portion of the downlink message is preempted. The portion that is preempted may include at least a portion of the first subband (e.g., or first component carrier) and at least a portion of the second subband (e.g., or second component carrier). In some examples, the UE 115-b may receive the preemption message via a USS for the UE 115-b, and a scrambling sequence (e.g., CRC) associated with the preemption message may be based on a UE identifier (e.g., C-RNTI) of the UE 115-b. In some other examples, the UE 115-b may receive the preemption message via a CSS associated with the UE, and the scrambling sequence associated with the preemption message may be based on a group RNTI (e.g., INT-RNTI, CI-RNTI) or the UE identifier. The preemption message may be received via a PDCCH and may include a DLPI.

In some examples, the portion of the downlink message that is preempted may correspond to a PCell for the UE and to one or more activated SCells associated with the UE. The PCell and the one or more activated SCells may belong to a same PUCCH group, a same TAG, or both.

In some implementations, the preemption message may include an indication of a priority (e.g., a priority indicator) of the downlink message relative to one or more other downlink messages. The preemption of at least the portion of the downlink message may be based on the priority. The priority of the downlink message may be based on a category of the UE, a service type associated with the downlink message, or a combination thereof. In some examples, the preemption message may include a SLIV, a RIV, that indicates the portion of the downlink message that is preempted.

In some examples, the preemption message may include a bitmap indicating a set of time-frequency resources that are to be preempted, and the set of time-frequency resources may correspond to one or more downlink messages. The set of time-frequency resources to be preempted may include the first subband and the second subband, or may include the first component carrier and the second component carrier. In some examples, the bitmap may include a first value indicating that the first subband (e.g., or component carrier) is preempted for a duration of time (e.g., a set of time blocks) and may include a second value indicating that a second subband (e.g., or second component carrier) is not preempted for the duration of time. In some other examples, the preemption message may include a first field indicating that both the first subband and the second subband are at least partially preempted and may include a second filed indicating both a first subset of time-frequency resources within the first subband and a second subset of time-frequency resources within the second subband that are preempted.

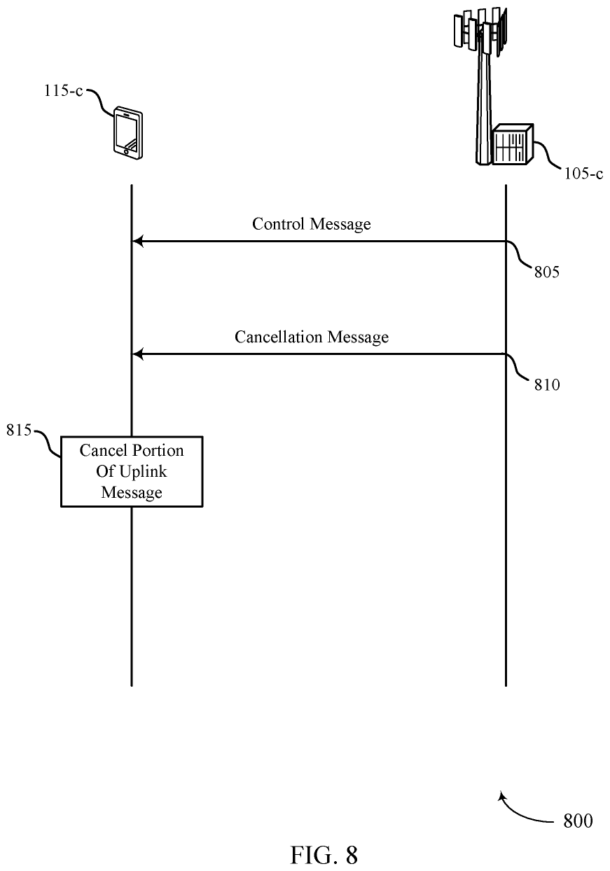

FIG. 8 shows an example of a process flow 800 that supports enhancements of DLPI and ULCI in accordance with one or more aspects of the present disclosure. The process flow 800 may implement or may be implemented by aspects of the wireless communications system 100, the wireless communications system 200, or the signaling diagram 300. For example, the process flow 800 may include a UE 115-c and a network entity 105-c, which may be examples of corresponding devices described herein.

In the following description of process flow 800, the operations may be performed in a different order than the order shown, or other operations may be added or removed from the process flow 800. For example, some operations may also be left out of process flow 800, may be performed in different orders or at different times, or other operations may be added to process flow 800. Although communications of the process flow 800 are shown occurring between a UE 115-c and a network entity 105-c, some aspects of some operations may also be performed by one or more other wireless devices, network devices, or network functions.

At 805, the UE 115-c may receive a control message (e.g., DCI) indicating scheduling information for an uplink message that is scheduled for transmission via a first subband of a first radio frequency spectrum band and via a second subband of a second radio frequency spectrum band that is different from the first radio frequency spectrum band. The second subband may be non-contiguous with the first subband. In some examples, the first subband and the second subband may be associated with a virtual cell (e.g., of the network entity 105-c) that supports communications for the UE 115-c. Additionally, or alternatively, the control message may indicate scheduling information for an uplink message that is scheduled for transmission via a first component carrier of a TAG (e.g., of an uplink carrier aggregation configuration) and via a second component carrier of the TAG.

At 810, the UE 115-c may receive a cancellation message (e.g., DCI, ULCI) indicating that at least a portion of the uplink message is canceled. The portion that is canceled may include at least a portion of the first subband (e.g., or first component carrier) and at least a portion of the second subband (e.g., or second component carrier). In some examples, the UE 115-b may receive the cancellation message via a USS for the UE 115-b, and a scrambling sequence (e.g., CRC) associated with the cancellation message may be based on a UE identifier (e.g., C-RNTI) of the UE 115-b. In some other examples, the UE 115-b may receive the cancellation message via a CSS associated with the UE, and the scrambling sequence associated with the cancellation message may be based on a group RNTI (e.g., INT-RNTI, CI-RNTI) or the UE identifier. The cancellation message may be received via a PDCCH and may include an ULCI.

In some examples, the portion of the uplink message that is canceled may correspond to a PCell for the UE and to one or more activated SCells associated with the UE. The PCell and the one or more activated SCells may belong to a same PUCCH group, a same TAG, or both.

In some implementations, the cancellation message may include an indication of a priority (e.g., a priority indicator) of the uplink message relative to one or more other uplink messages. The cancellation of at least the portion of the uplink message may be based on the priority. The priority of the downlink message may be based on a category of the UE, a service type associated with the downlink message, or a combination thereof. In some examples, the cancellation message may include a SLIV, a RIV, that indicates the portion of the uplink message that is canceled. In some examples, the cancellation message may cancel at least a portion of a PUCCH transmission (e.g., including repetitions) or a PRACH transmission (e.g., including repetitions) indicated by PDCCH (e.g., DCI).

In some examples, the cancellation message may include a bitmap indicating a set of time-frequency resources that are to be canceled, and the set of time-frequency resources may correspond to one or more uplink messages. The set of time-frequency resources to be canceled may include the first subband and the second subband, or may include the first component carrier and the second component carrier. In some examples, the bitmap may include a first value indicating that the first subband (e.g., or component carrier) is canceled for a duration of time (e.g., a set of time blocks) and may include a second value indicating that a second subband (e.g., or second component carrier) is not canceled for the duration of time. In some other examples, the cancellation message may include a first field indicating that both the first subband and the second subband are at least partially canceled and may include a second filed indicating both a first subset of time-frequency resources within the first subband and a second subset of time-frequency resources within the second subband that are canceled.

At 815, the UE 115-c may cancel transmission of at least the portion of the uplink message based on the cancellation message. In some examples, the UE 115-c may cancel a portion of the uplink message and transmit another portion of the uplink message based on the set of time-frequency resources indicated by the cancellation message.

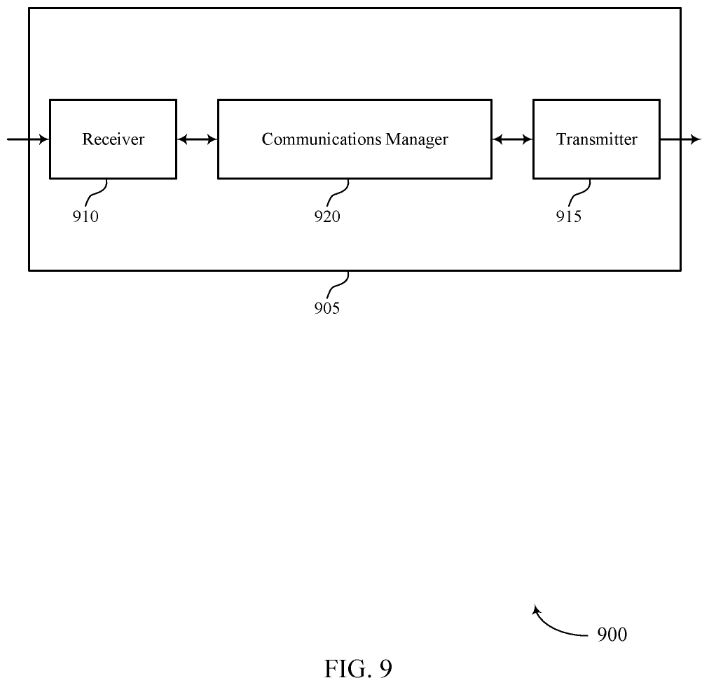

FIG. 9 shows a block diagram 900 of a device 905 that supports enhancements of DLPI and ULCI in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to enhancements of DLPI and ULCI). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to enhancements of DLPI and ULCI). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of enhancements of DLPI and ULCI as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE. The communications manager 920 is capable of, configured to, or operable to support a means for monitoring the first subband and the second subband for the downlink message from the virtual cell based on the scheduling information. The communications manager 920 is capable of, configured to, or operable to support a means for receiving a preemption message indicating that at least a portion of the downlink message is preempted, the portion corresponding to the first subband and the second subband.

Additionally, or alternatively, the communications manager 920 may support wireless communications in accordance with examples as disclosed herein. For example, the communications manager 920 is capable of, configured to, or operable to support a means for receiving a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE. The communications manager 920 is capable of, configured to, or operable to support a means for receiving a cancellation message indicating that at least a portion of the uplink message is canceled based on the scheduling information, the portion corresponding to the first subband and the second subband. The communications manager 920 is capable of, configured to, or operable to support a means for canceling transmission of at least the portion of the uplink message based on the cancellation message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption, increased spectral efficiency, and more efficient utilization of communication resources.

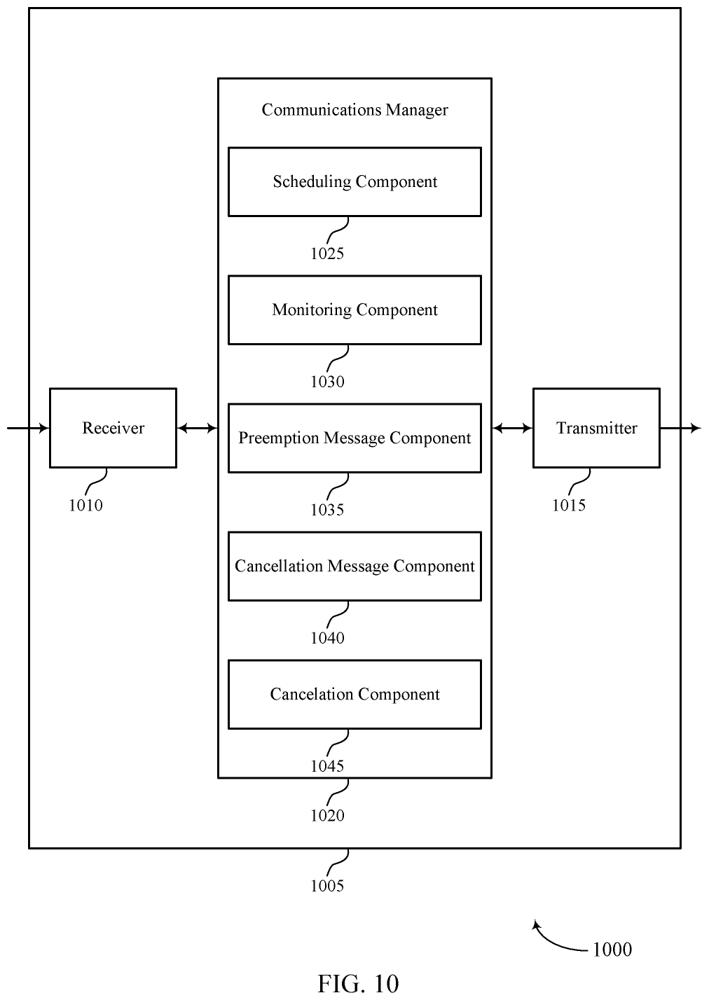

FIG. 10 shows a block diagram 1000 of a device 1005 that supports enhancements of DLPI and ULCI in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to enhancements of DLPI and ULCI). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to enhancements of DLPI and ULCI). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of enhancements of DLPI and ULCI as described herein. For example, the communications manager 1020 may include a scheduling component 1025, a monitoring component 1030, a preemption message component 1035, a cancellation message component 1040, a cancelation component 1045, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The scheduling component 1025 is capable of, configured to, or operable to support a means for receiving a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE. The monitoring component 1030 is capable of, configured to, or operable to support a means for monitoring the first subband and the second subband for the downlink message from the virtual cell based on the scheduling information. The preemption message component 1035 is capable of, configured to, or operable to support a means for receiving a preemption message indicating that at least a portion of the downlink message is preempted, the portion corresponding to the first subband and the second subband.

Additionally, or alternatively, the communications manager 1020 may support wireless communications in accordance with examples as disclosed herein. The scheduling component 1025 is capable of, configured to, or operable to support a means for receiving a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE. The cancellation message component 1040 is capable of, configured to, or operable to support a means for receiving a cancellation message indicating that at least a portion of the uplink message is canceled based on the scheduling information, the portion corresponding to the first subband and the second subband. The cancelation component 1045 is capable of, configured to, or operable to support a means for canceling transmission of at least the portion of the uplink message based on the cancellation message.

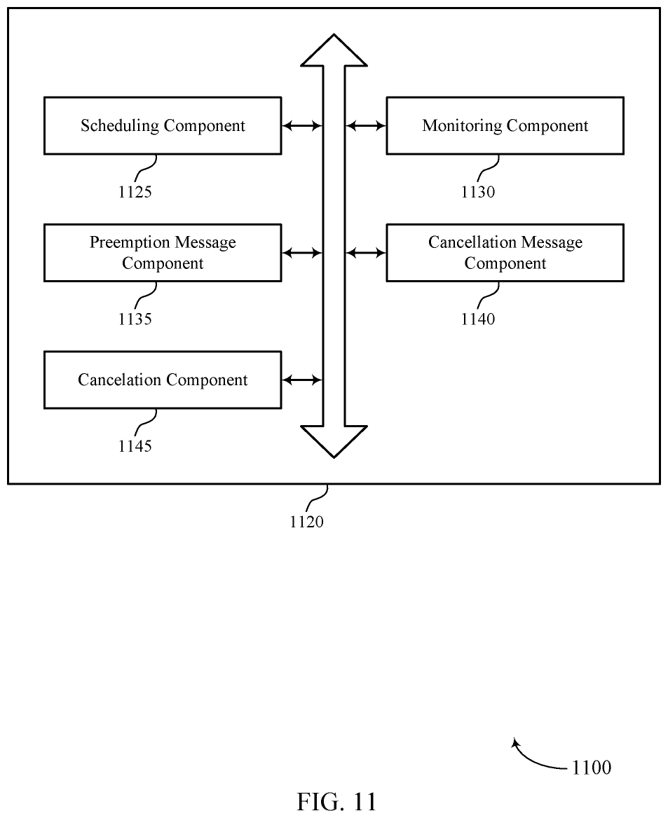

FIG. 11 shows a block diagram 1100 of a communications manager 1120 that supports enhancements of DLPI and ULCI in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of enhancements of DLPI and ULCI as described herein. For example, the communications manager 1120 may include a scheduling component 1125, a monitoring component 1130, a preemption message component 1135, a cancellation message component 1140, a cancelation component 1145, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The scheduling component 1125 is capable of, configured to, or operable to support a means for receiving a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE. The monitoring component 1130 is capable of, configured to, or operable to support a means for monitoring the first subband and the second subband for the downlink message from the virtual cell based on the scheduling information. The preemption message component 1135 is capable of, configured to, or operable to support a means for receiving a preemption message indicating that at least a portion of the downlink message is preempted, the portion corresponding to the first subband and the second subband.

In some examples, to support receiving the preemption message, the preemption message component 1135 is capable of, configured to, or operable to support a means for receiving the preemption message via a USS for the UE, where a scrambling sequence associated with the preemption message is based on a UE identifier of the UE.

In some examples, to support receiving the preemption message, the preemption message component 1135 is capable of, configured to, or operable to support a means for receiving the preemption message via a CSS associated with the UE, where a scrambling sequence associated with the preemption message is based on a group RNTI or a UE identifier of the UE.

In some examples, the portion of the downlink message that is preempted corresponds to a PCell for the UE and to one or more activated SCells associated with the UE.

In some examples, the PCell and the one or more activated SCells are associated with a same PUCCH group, a same TAG, or both.

In some examples, to support receiving the preemption message, the preemption message component 1135 is capable of, configured to, or operable to support a means for receiving an indication of whether the portion of the downlink message that is preempted occurs before or after reception of the preemption message and an indication of a time period corresponding to the portion of the downlink message that is preempted.

In some examples, to support receiving the preemption message, the preemption message component 1135 is capable of, configured to, or operable to support a means for receiving an indication of a priority of the downlink message relative to one or more other downlink messages, where the preemption of at least the portion of the downlink message is based on the priority.

In some examples, to support receiving the preemption message, the preemption message component 1135 is capable of, configured to, or operable to support a means for receiving a SLIV, a RIV, or both indicative of the portion of the downlink message that is preempted.

In some examples, to support receiving the preemption message, the preemption message component 1135 is capable of, configured to, or operable to support a means for receiving an indication of a bitmap indicating a set of time-frequency resources corresponding to the portion of the downlink message that is preempted, where the set of time-frequency resources corresponds to both the first subband and the second subband.

In some examples, the bitmap includes a first value indicating that the first subband is preempted for a duration of time and includes a second value indicating that the second subband is not preempted for the duration of time.

In some examples, the preemption message includes a first field indicating that both the first subband and the second subband are at least partially preempted and includes a second field indicating both a first subset of time-frequency resources within the first subband and a second subset of time-frequency resources within the second subband that are preempted.

Additionally, or alternatively, the communications manager 1120 may support wireless communications in accordance with examples as disclosed herein. In some examples, the scheduling component 1125 is capable of, configured to, or operable to support a means for receiving a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE. The cancellation message component 1140 is capable of, configured to, or operable to support a means for receiving a cancellation message indicating that at least a portion of the uplink message is canceled based on the scheduling information, the portion corresponding to the first subband and the second subband. The cancelation component 1145 is capable of, configured to, or operable to support a means for canceling transmission of at least the portion of the uplink message based on the cancellation message.

In some examples, to support receiving the cancellation message, the cancellation message component 1140 is capable of, configured to, or operable to support a means for receiving the cancellation message via a USS for the UE, where a scrambling sequence associated with the cancellation message is based on a UE identifier of the UE.

In some examples, to support receiving the cancellation message, the cancellation message component 1140 is capable of, configured to, or operable to support a means for receiving the cancellation message via a CSS associated with the UE, where a scrambling sequence associated with the cancellation message is based on a group RNTI or a UE identifier of the UE.

In some examples, the portion of the uplink message that is canceled corresponds to a PCell for the UE and to one or more activated SCells associated with the UE.

In some examples, the PCell and the one or more activated SCells are associated with a same PUCCH group, a same TAG, or both.

In some examples, to support receiving the cancellation message, the cancellation message component 1140 is capable of, configured to, or operable to support a means for receiving an indication of a priority of the uplink message relative to one or more other uplink messages, where cancelling transmission of at least the portion of the uplink message is based on the priority.

In some examples, to support receiving the cancellation message, the cancellation message component 1140 is capable of, configured to, or operable to support a means for receiving a SLIV, a RIV, or both indicative of the portion of the uplink message that is canceled.

In some examples, to support receiving the cancellation message, the cancellation message component 1140 is capable of, configured to, or operable to support a means for receiving an indication of a bitmap indicating a set of time-frequency resources corresponding to the portion of the uplink message that is canceled, where the set of time-frequency resources corresponds to both the first subband and the second subband.

In some examples, the bitmap includes a first value indicating that the first subband is canceled for a duration of time and includes a second value indicating that the second subband is not canceled for the duration of time.

In some examples, the cancellation message includes a first field indicating that both the first subband and the second subband are at least partially canceled and a second field indicating both a first subset of time-frequency resources within the first subband and a second subset of time-frequency resources within the second subband that are canceled.

In some examples, the uplink message is at least one of an uplink control message or a random access message.

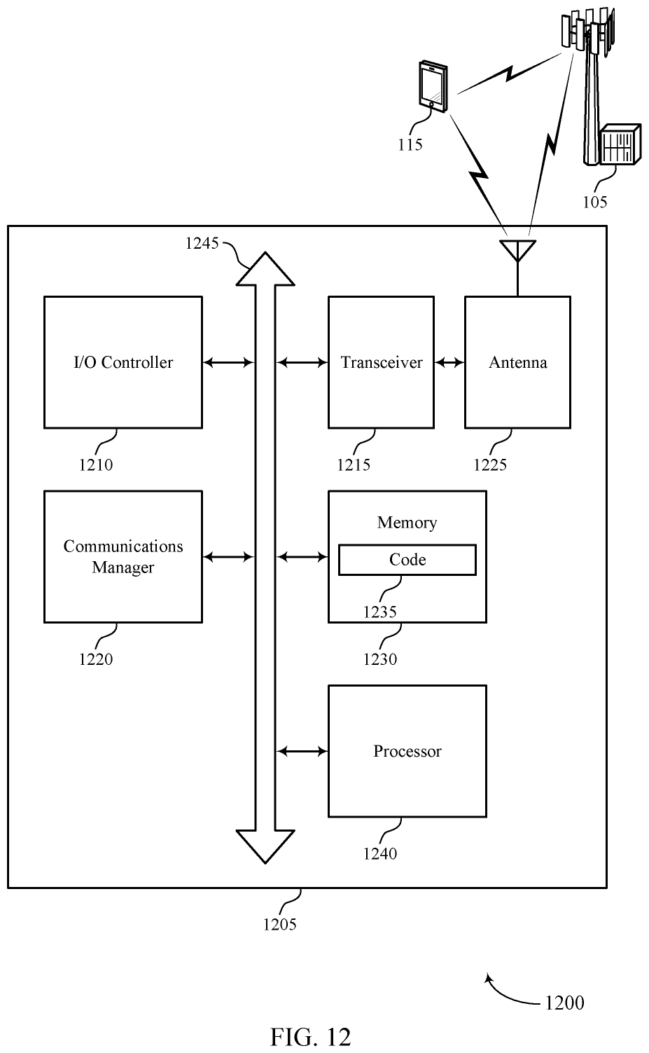

FIG. 12 shows a diagram of a system 1200 including a device 1205 that supports enhancements of DLPI and ULCI in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting enhancements of DLPI and ULCI). For example, the device 1205 or a component of the device 1205 may include at least one processor 1240 and at least one memory 1230 coupled with or to the at least one processor 1240, the at least one processor 1240 and the at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE. The communications manager 1220 is capable of, configured to, or operable to support a means for monitoring the first subband and the second subband for the downlink message from the virtual cell based on the scheduling information. The communications manager 1220 is capable of, configured to, or operable to support a means for receiving a preemption message indicating that at least a portion of the downlink message is preempted, the portion corresponding to the first subband and the second subband.

Additionally, or alternatively, the communications manager 1220 may support wireless communications in accordance with examples as disclosed herein. For example, the communications manager 1220 is capable of, configured to, or operable to support a means for receiving a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE. The communications manager 1220 is capable of, configured to, or operable to support a means for receiving a cancellation message indicating that at least a portion of the uplink message is canceled based on the scheduling information, the portion corresponding to the first subband and the second subband. The communications manager 1220 is capable of, configured to, or operable to support a means for canceling transmission of at least the portion of the uplink message based on the cancellation message.

By including or configuring the communications manager 1220 in accordance with examples as described herein, the device 1205 may support techniques for reduced power consumption, more efficient utilization of communication resources, improved user experience related to reduced processing, and increased scheduling flexibility.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of enhancements of DLPI and ULCI as described herein, or the at least one processor 1240 and the at least one memory 1230 may be otherwise configured to, individually or collectively, perform or support such operations.

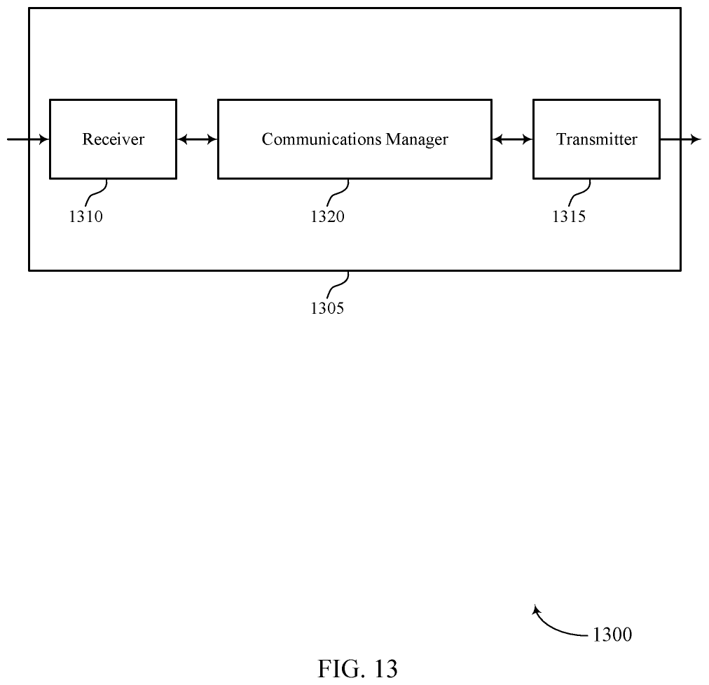

FIG. 13 shows a block diagram 1300 of a device 1305 that supports enhancements of DLPI and ULCI in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of enhancements of DLPI and ULCI as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for transmitting a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE. The communications manager 1320 is capable of, configured to, or operable to support a means for transmitting a preemption message indicating that at least a portion of the downlink message is preempted, the portion corresponding to the first subband and the second subband.

Additionally, or alternatively, the communications manager 1320 may support wireless communications in accordance with examples as disclosed herein. For example, the communications manager 1320 is capable of, configured to, or operable to support a means for transmitting a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE. The communications manager 1320 is capable of, configured to, or operable to support a means for transmitting a cancellation message indicating that at least a portion of the uplink message is canceled based on the scheduling information, the portion corresponding to the first subband and the second subband.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced power consumption, increased spectral efficiency, and more efficient utilization of communication resources.

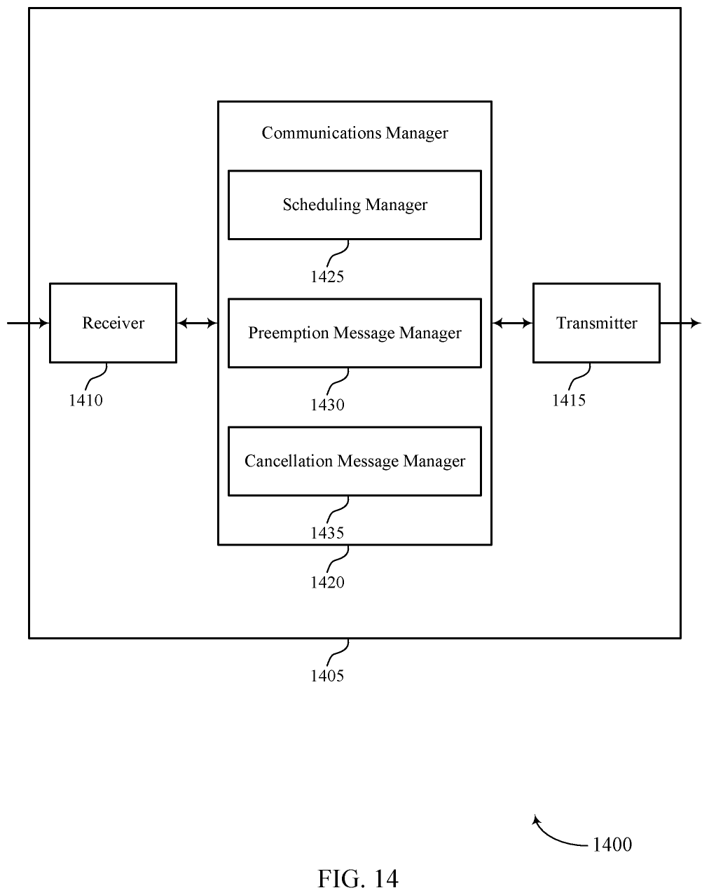

FIG. 14 shows a block diagram 1400 of a device 1405 that supports enhancements of DLPI and ULCI in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of enhancements of DLPI and ULCI as described herein. For example, the communications manager 1420 may include a scheduling manager 1425, a preemption message manager 1430, a cancellation message manager 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The scheduling manager 1425 is capable of, configured to, or operable to support a means for transmitting a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE. The preemption message manager 1430 is capable of, configured to, or operable to support a means for transmitting a preemption message indicating that at least a portion of the downlink message is preempted, the portion corresponding to the first subband and the second subband.

Additionally, or alternatively, the communications manager 1420 may support wireless communications in accordance with examples as disclosed herein. The scheduling manager 1425 is capable of, configured to, or operable to support a means for transmitting a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE. The cancellation message manager 1435 is capable of, configured to, or operable to support a means for transmitting a cancellation message indicating that at least a portion of the uplink message is canceled based on the scheduling information, the portion corresponding to the first subband and the second subband.

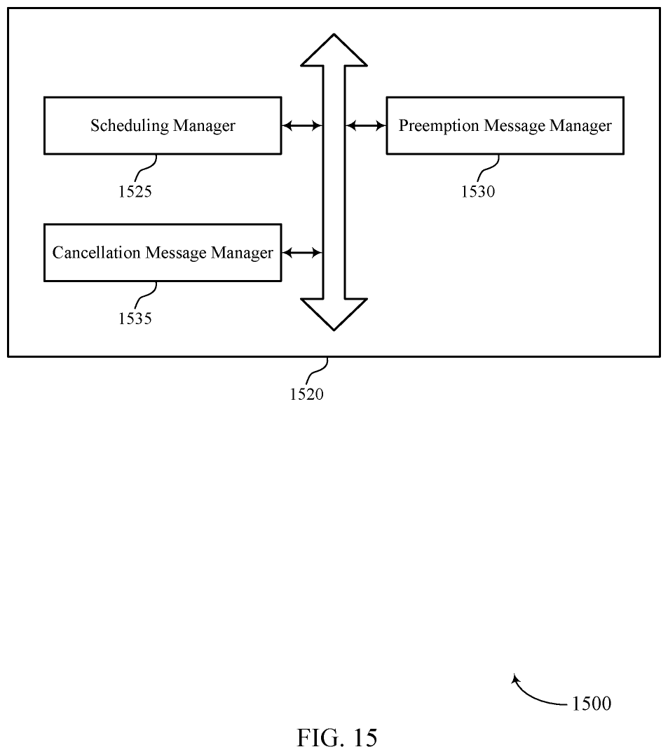

FIG. 15 shows a block diagram 1500 of a communications manager 1520 that supports enhancements of DLPI and ULCI in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of enhancements of DLPI and ULCI as described herein. For example, the communications manager 1520 may include a scheduling manager 1525, a preemption message manager 1530, a cancellation message manager 1535, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The scheduling manager 1525 is capable of, configured to, or operable to support a means for transmitting a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE. The preemption message manager 1530 is capable of, configured to, or operable to support a means for transmitting a preemption message indicating that at least a portion of the downlink message is preempted, the portion corresponding to the first subband and the second subband.

In some examples, to support transmitting the preemption message, the preemption message manager 1530 is capable of, configured to, or operable to support a means for transmitting the preemption message via a USS for the UE, where a scrambling sequence associated with the preemption message is based on a UE identifier of the UE.

In some examples, to support transmitting the preemption message, the preemption message manager 1530 is capable of, configured to, or operable to support a means for transmitting the preemption message via a CSS associated with the UE, where a scrambling sequence associated with the preemption message is based on a group RNTI or a UE identifier of the UE.

In some examples, to support transmitting the preemption message, the preemption message manager 1530 is capable of, configured to, or operable to support a means for transmitting an indication of whether the portion of the downlink message that is preempted occurs before or after transmission of the preemption message and an indication of a time period corresponding to the portion of the downlink message that is preempted.

In some examples, to support transmitting the preemption message, the preemption message manager 1530 is capable of, configured to, or operable to support a means for transmitting an indication of a priority of the downlink message relative to one or more other downlink messages.

In some examples, to support transmitting the preemption message, the preemption message manager 1530 is capable of, configured to, or operable to support a means for transmitting a SLIV, a RIV, or both indicative of the portion of the downlink message that is preempted.

In some examples, to support transmitting the preemption message, the preemption message manager 1530 is capable of, configured to, or operable to support a means for transmitting an indication of a bitmap indicating a set of time-frequency resources corresponding to the portion of the downlink message that is preempted, where the set of time-frequency resources corresponds to both the first subband and the second subband.

Additionally, or alternatively, the communications manager 1520 may support wireless communications in accordance with examples as disclosed herein. In some examples, the scheduling manager 1525 is capable of, configured to, or operable to support a means for transmitting a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE. The cancellation message manager 1535 is capable of, configured to, or operable to support a means for transmitting a cancellation message indicating that at least a portion of the uplink message is canceled based on the scheduling information, the portion corresponding to the first subband and the second subband.

In some examples, to support transmitting the cancellation message, the cancellation message manager 1535 is capable of, configured to, or operable to support a means for transmitting the cancellation message via a USS for the UE, where a scrambling sequence associated with the cancellation message is based on a UE identifier of the UE.

In some examples, to support transmitting the cancellation message, the cancellation message manager 1535 is capable of, configured to, or operable to support a means for transmitting the cancellation message via a CSS associated with the UE, where a scrambling sequence associated with the cancellation message is based on a group RNTI or a UE identifier of the UE.

In some examples, to support transmitting the cancellation message, the cancellation message manager 1535 is capable of, configured to, or operable to support a means for transmitting an indication of a priority of the uplink message relative to one or more other uplink messages.

In some examples, to support transmitting the cancellation message, the cancellation message manager 1535 is capable of, configured to, or operable to support a means for transmitting a SLIV, a RIV, or both indicative of the portion of the uplink message that is canceled.

In some examples, to support transmitting the cancellation message, the cancellation message manager 1535 is capable of, configured to, or operable to support a means for transmitting an indication of a bitmap indicating a set of time-frequency resources corresponding to the portion of the uplink message that is canceled, where the set of time-frequency resources corresponds to both the first subband and the second subband.

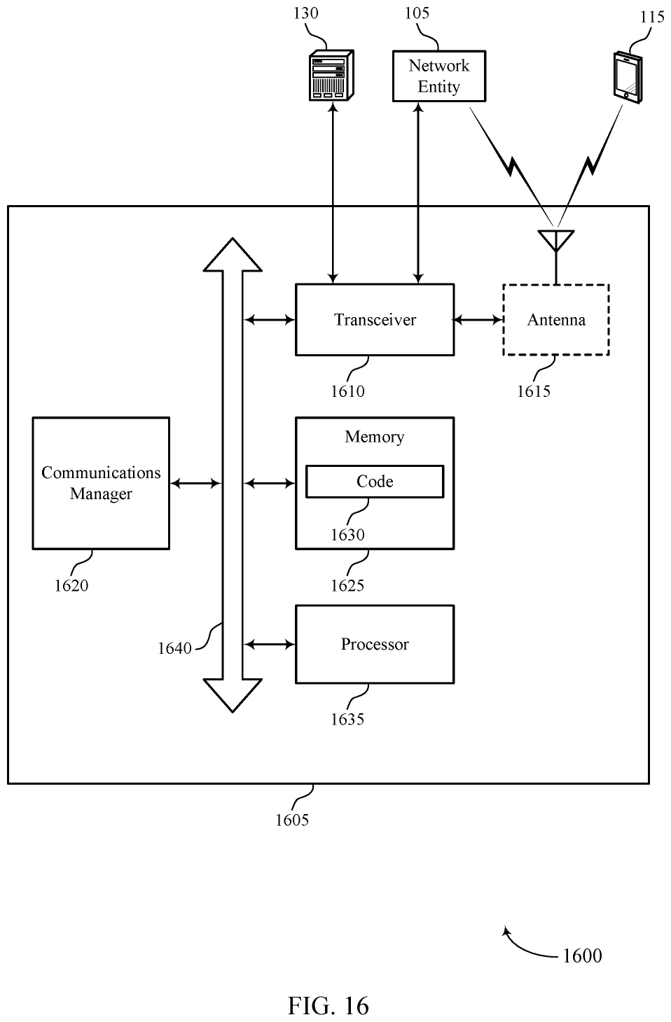

FIG. 16 shows a diagram of a system 1600 including a device 1605 that supports enhancements of DLPI and ULCI in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting enhancements of DLPI and ULCI). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625). In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network devices 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for transmitting a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE. The communications manager 1620 is capable of, configured to, or operable to support a means for transmitting a preemption message indicating that at least a portion of the downlink message is preempted, the portion corresponding to the first subband and the second subband.

Additionally, or alternatively, the communications manager 1620 may support wireless communications in accordance with examples as disclosed herein. For example, the communications manager 1620 is capable of, configured to, or operable to support a means for transmitting a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for a UE. The communications manager 1620 is capable of, configured to, or operable to support a means for transmitting a cancellation message indicating that at least a portion of the uplink message is canceled based on the scheduling information, the portion corresponding to the first subband and the second subband.

By including or configuring the communications manager 1620 in accordance with examples as described herein, the device 1605 may support techniques for reduced power consumption, more efficient utilization of communication resources, improved user experience related to reduced processing, and increased scheduling flexibility.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of enhancements of DLPI and ULCI as described herein, or the at least one processor 1635 and the at least one memory 1625 may be otherwise configured to, individually or collectively, perform or support such operations.

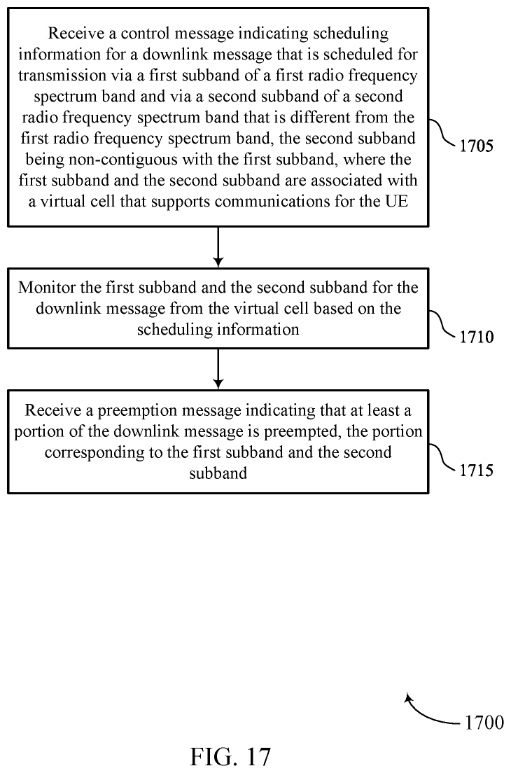

FIG. 17 shows a flowchart illustrating a method 1700 that supports enhancements of DLPI and ULCI in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE. The operations of 1705 may be performed in accordance with examples as disclosed herein. In some examples, aspects of the operations of 1705 may be performed by a scheduling component 1125 as described with reference to FIG. 11.

At 1710, the method may include monitoring the first subband and the second subband for the downlink message from the virtual cell based on the scheduling information. The operations of 1710 may be performed in accordance with examples as disclosed herein. In some examples, aspects of the operations of 1710 may be performed by a monitoring component 1130 as described with reference to FIG. 11.

At 1715, the method may include receiving a preemption message indicating that at least a portion of the downlink message is preempted, the portion corresponding to the first subband and the second subband. The operations of 1715 may be performed in accordance with examples as disclosed herein. In some examples, aspects of the operations of 1715 may be performed by a preemption message component 1135 as described with reference to FIG. 11.

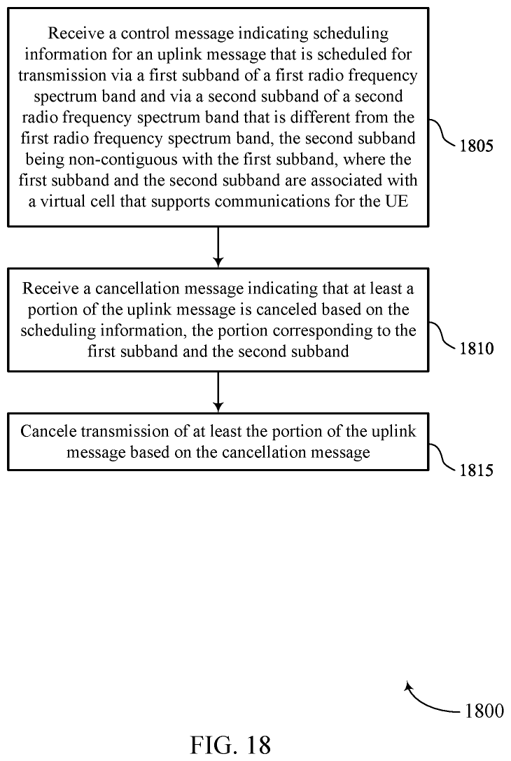

FIG. 18 shows a flowchart illustrating a method 1800 that supports enhancements of DLPI and ULCI in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, where the first subband and the second subband are associated with a virtual cell that supports communications for the UE. The operations of 1805 may be performed in accordance with examples as disclosed herein. In some examples, aspects of the operations of 1805 may be performed by a scheduling component 1125 as described with reference to FIG. 11.

At 1810, the method may include receiving a cancellation message indicating that at least a portion of the uplink message is canceled based on the scheduling information, the portion corresponding to the first subband and the second subband. The operations of 1810 may be performed in accordance with examples as disclosed herein. In some examples, aspects of the operations of 1810 may be performed by a cancellation message component 1140 as described with reference to FIG. 11.

At 1815, the method may include canceling transmission of at least the portion of the uplink message based on the cancellation message. The operations of 1815 may be performed in accordance with examples as disclosed herein. In some examples, aspects of the operations of 1815 may be performed by a cancelation component 1145 as described with reference to FIG. 11.

The following provides an overview of aspects of the present disclosure:

Aspect 1: A method for wireless communications by a UE, comprising: receiving a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, wherein the first subband and the second subband are associated with a virtual cell that supports communications for the UE; monitoring the first subband and the second subband for the downlink message from the virtual cell based at least in part on the scheduling information; and receiving a preemption message indicating that at least a portion of the downlink message is preempted, the portion corresponding to the first subband and the second subband.

Aspect 2: The method of aspect 1, wherein receiving the preemption message comprises: receiving the preemption message via a USS for the UE, wherein a scrambling sequence associated with the preemption message is based at least in part on a UE identifier of the UE.

Aspect 3: The method of any of aspects 1 through 2, wherein receiving the preemption message comprises: receiving the preemption message via a CSS associated with the UE, wherein a scrambling sequence associated with the preemption message is based at least in part on a group RNTI or a UE identifier of the UE.

Aspect 4: The method of any of aspects 1 through 3, wherein the portion of the downlink message that is preempted corresponds to a PCell for the UE and to one or more activated SCells associated with the UE.

Aspect 5: The method of aspect 4, wherein the PCell and the one or more activated SCells are associated with a same PUCCH group, a same TAG, or both.

Aspect 6: The method of any of aspects 1 through 5, wherein receiving the preemption message comprises: receiving an indication of whether the portion of the downlink message that is preempted occurs before or after reception of the preemption message and an indication of a time period corresponding to the portion of the downlink message that is preempted.

Aspect 7: The method of any of aspects 1 through 6, wherein receiving the preemption message comprises: receiving an indication of a priority of the downlink message relative to one or more other downlink messages, wherein the preemption of at least the portion of the downlink message is based at least in part on the priority.

Aspect 8: The method of any of aspects 1 through 7, wherein receiving the preemption message comprises: receiving a SLIV, a RIV, or both indicative of the portion of the downlink message that is preempted.

Aspect 9: The method of any of aspects 1 through 8, wherein receiving the preemption message comprises: receiving an indication of a bitmap indicating a set of time-frequency resources corresponding to the portion of the downlink message that is preempted, wherein the set of time-frequency resources corresponds to both the first subband and the second subband.

Aspect 10: The method of aspect 9, wherein the bitmap comprises a first value indicating that the first subband is preempted for a duration of time and comprises a second value indicating that the second subband is not preempted for the duration of time.

Aspect 11: The method of any of aspects 9 through 10, wherein the preemption message comprises a first field indicating that both the first subband and the second subband are at least partially preempted and comprises a second field indicating both a first subset of time-frequency resources within the first subband and a second subset of time-frequency resources within the second subband that are preempted.

Aspect 12: A method for wireless communications by a UE, comprising: receiving a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, wherein the first subband and the second subband are associated with a virtual cell that supports communications for the UE; receiving a cancellation message indicating that at least a portion of the uplink message is canceled based at least in part on the scheduling information, the portion corresponding to the first subband and the second subband; and canceling transmission of at least the portion of the uplink message based at least in part on the cancellation message.

Aspect 13: The method of aspect 12, wherein receiving the cancellation message comprises: receiving the cancellation message via a USS for the UE, wherein a scrambling sequence associated with the cancellation message is based at least in part on a UE identifier of the UE.

Aspect 14: The method of any of aspects 12 through 13, wherein receiving the cancellation message comprises: receiving the cancellation message via a CSS associated with the UE, wherein a scrambling sequence associated with the cancellation message is based at least in part on a group RNTI or a UE identifier of the UE.

Aspect 15: The method of any of aspects 12 through 14, wherein the portion of the uplink message that is canceled corresponds to a PCell for the UE and to one or more activated SCells associated with the UE.

Aspect 16: The method of aspect 15, wherein the PCell and the one or more activated SCells are associated with a same PUCCH group, a same TAG, or both.

Aspect 17: The method of any of aspects 12 through 16, wherein receiving the cancellation message comprises: receiving an indication of a priority of the uplink message relative to one or more other uplink messages, wherein cancelling transmission of at least the portion of the uplink message is based at least in part on the priority.

Aspect 18: The method of any of aspects 12 through 17, wherein receiving the cancellation message comprises: receiving a SLIV, a RIV, or both indicative of the portion of the uplink message that is canceled.

Aspect 19: The method of any of aspects 12 through 18, wherein receiving the cancellation message comprises: receiving an indication of a bitmap indicating a set of time-frequency resources corresponding to the portion of the uplink message that is canceled, wherein the set of time-frequency resources corresponds to both the first subband and the second subband.

Aspect 20: The method of aspect 19, wherein the bitmap comprises a first value indicating that the first subband is canceled for a duration of time and comprises a second value indicating that the second subband is not canceled for the duration of time.

Aspect 21: The method of any of aspects 19 through 20, wherein the cancellation message comprises a first field indicating that both the first subband and the second subband are at least partially canceled and a second field indicating both a first subset of time-frequency resources within the first subband and a second subset of time-frequency resources within the second subband that are canceled.

Aspect 22: The method of any of aspects 12 through 21, wherein the uplink message is at least one of an uplink control message or a random access message.

Aspect 23: A method for wireless communications by a network entity, comprising: transmitting a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, wherein the first subband and the second subband are associated with a virtual cell that supports communications for a UE; and transmitting a preemption message indicating that at least a portion of the downlink message is preempted, the portion corresponding to the first subband and the second subband.

Aspect 24: The method of aspect 23, wherein transmitting the preemption message comprises: transmitting the preemption message via a USS for the UE, wherein a scrambling sequence associated with the preemption message is based at least in part on a UE identifier of the UE.

Aspect 25: The method of any of aspects 23 through 24, wherein transmitting the preemption message comprises: transmitting the preemption message via a CSS associated with the UE, wherein a scrambling sequence associated with the preemption message is based at least in part on a group RNTI or a UE identifier of the UE.

Aspect 26: The method of any of aspects 23 through 25, wherein transmitting the preemption message comprises: transmitting an indication of whether the portion of the downlink message that is preempted occurs before or after transmission of the preemption message and an indication of a time period corresponding to the portion of the downlink message that is preempted.

Aspect 27: The method of any of aspects 23 through 26, wherein transmitting the preemption message comprises: transmitting an indication of a priority of the downlink message relative to one or more other downlink messages.

Aspect 28: The method of any of aspects 23 through 27, wherein transmitting the preemption message comprises: transmitting a SLIV, a RIV, or both indicative of the portion of the downlink message that is preempted.

Aspect 29: The method of any of aspects 23 through 28, wherein transmitting the preemption message comprises: transmitting an indication of a bitmap indicating a set of time-frequency resources corresponding to the portion of the downlink message that is preempted, wherein the set of time-frequency resources corresponds to both the first subband and the second subband.

Aspect 30: A method for wireless communications by a network entity, comprising: transmitting a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, wherein the first subband and the second subband are associated with a virtual cell that supports communications for a UE; and transmitting a cancellation message indicating that at least a portion of the uplink message is canceled based at least in part on the scheduling information, the portion corresponding to the first subband and the second subband.

Aspect 31: The method of aspect 30, wherein transmitting the cancellation message comprises: transmitting the cancellation message via a USS for the UE, wherein a scrambling sequence associated with the cancellation message is based at least in part on a UE identifier of the UE.

Aspect 32: The method of any of aspects 30 through 31, wherein transmitting the cancellation message comprises: transmitting the cancellation message via a CSS associated with the UE, wherein a scrambling sequence associated with the cancellation message is based at least in part on a group RNTI or a UE identifier of the UE.

Aspect 33: The method of any of aspects 30 through 32, wherein transmitting the cancellation message comprises: transmitting an indication of a priority of the uplink message relative to one or more other uplink messages.

Aspect 34: The method of any of aspects 30 through 33, wherein transmitting the cancellation message comprises: transmitting a SLIV, a RIV, or both indicative of the portion of the uplink message that is canceled.

Aspect 35: The method of any of aspects 30 through 34, wherein transmitting the cancellation message comprises: transmitting an indication of a bitmap indicating a set of time-frequency resources corresponding to the portion of the uplink message that is canceled, wherein the set of time-frequency resources corresponds to both the first subband and the second subband.

Aspect 36: A UE for wireless communications, comprising one or more memories storing processor-executable code, and one or more processors coupled with the one or more memories and individually or collectively operable to execute the code to cause the UE to perform a method of any of aspects 1 through 11.

Aspect 37: A UE for wireless communications, comprising at least one means for performing a method of any of aspects 1 through 11.

Aspect 38: A non-transitory computer-readable medium storing code for wireless communications, the code comprising instructions executable by one or more processors to perform a method of any of aspects 1 through 11.

Aspect 39: A UE for wireless communications, comprising one or more memories storing processor-executable code, and one or more processors coupled with the one or more memories and individually or collectively operable to execute the code to cause the UE to perform a method of any of aspects 12 through 22.

Aspect 40: A UE for wireless communications, comprising at least one means for performing a method of any of aspects 12 through 22.

Aspect 41: A non-transitory computer-readable medium storing code for wireless communications, the code comprising instructions executable by one or more processors to perform a method of any of aspects 12 through 22.

Aspect 42: A network entity for wireless communications, comprising one or more memories storing processor-executable code, and one or more processors coupled with the one or more memories and individually or collectively operable to execute the code to cause the network entity to perform a method of any of aspects 23 through 29.

Aspect 43: A network entity for wireless communications, comprising at least one means for performing a method of any of aspects 23 through 29.

Aspect 44: A non-transitory computer-readable medium storing code for wireless communications, the code comprising instructions executable by one or more processors to perform a method of any of aspects 23 through 29.

Aspect 45: A network entity for wireless communications, comprising one or more memories storing processor-executable code, and one or more processors coupled with the one or more memories and individually or collectively operable to execute the code to cause the network entity to perform a method of any of aspects 30 through 35.

Aspect 46: A network entity for wireless communications, comprising at least one means for performing a method of any of aspects 30 through 35.

Aspect 47: A non-transitory computer-readable medium storing code for wireless communications, the code comprising instructions executable by one or more processors to perform a method of any of aspects 30 through 35.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, wherein the first subband and the second subband are associated with a virtual cell that supports communications for the UE;
monitor the first subband and the second subband for the downlink message from the virtual cell based at least in part on the scheduling information; and
receive a preemption message indicating that at least a portion of the downlink message is preempted, the portion corresponding to the first subband and the second subband.

2. The UE of claim 1, wherein, to receive the preemption message, the one or more processors are individually or collectively operable to execute the code to cause the UE to:
receive the preemption message via a UE specific search space for the UE, wherein a scrambling sequence associated with the preemption message is based at least in part on a UE identifier of the UE.

3. The UE of claim 1, wherein, to receive the preemption message, the one or more processors are individually or collectively operable to execute the code to cause the UE to:
receive the preemption message via a common search space associated with the UE, wherein a scrambling sequence associated with the preemption message is based at least in part on a group radio network temporary identifier or a UE identifier of the UE.

4. The UE of claim 1, wherein the portion of the downlink message that is preempted corresponds to a primary cell for the UE and to one or more activated secondary cells associated with the UE.

5. The UE of claim 4, wherein the primary cell and the one or more activated secondary cells are associated with a same physical uplink control channel group, a same timing advance group, or both.

6. The UE of claim 1, wherein, to receive the preemption message, the one or more processors are individually or collectively operable to execute the code to cause the UE to:
receive an indication of whether the portion of the downlink message that is preempted occurs before or after reception of the preemption message and an indication of a time period corresponding to the portion of the downlink message that is preempted.

7. The UE of claim 1, wherein, to receive the preemption message, the one or more processors are individually or collectively operable to execute the code to cause the UE to:
receive an indication of a priority of the downlink message relative to one or more other downlink messages, wherein the preemption of at least the portion of the downlink message is based at least in part on the priority.

8. The UE of claim 1, wherein, to receive the preemption message, the one or more processors are individually or collectively operable to execute the code to cause the UE to:
receive a start and length indicator value (SLIV), a resource indicator value (RIV), or both indicative of the portion of the downlink message that is preempted.

9. The UE of claim 1, wherein, to receive the preemption message, the one or more processors are individually or collectively operable to execute the code to cause the UE to:
receive an indication of a bitmap indicating a set of time-frequency resources corresponding to the portion of the downlink message that is preempted, wherein the set of time-frequency resources corresponds to both the first subband and the second subband.

10. The UE of claim 9, wherein the bitmap comprises a first value indicating that the first subband is preempted for a duration of time and comprises a second value indicating that the second subband is not preempted for the duration of time.

11. The UE of claim 9, wherein the preemption message comprises a first field indicating that both the first subband and the second subband are at least partially preempted and comprises a second field indicating both a first subset of time-frequency resources within the first subband and a second subset of time-frequency resources within the second subband that are preempted.

12. A user equipment (UE), comprising:
one or more memories storing processor-executable code; and
one or more processors coupled with the one or more memories and individually or collectively operable to execute the code to cause the UE to:
receive a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, wherein the first subband and the second subband are associated with a virtual cell that supports communications for the UE;
receive a cancellation message indicating that at least a portion of the uplink message is canceled based at least in part on the scheduling information, the portion corresponding to the first subband and the second subband; and
cancel transmission of at least the portion of the uplink message based at least in part on the cancellation message.

13. The UE of claim 12, wherein, to receive the cancellation message, the one or more processors are individually or collectively operable to execute the code to cause the UE to:
receive the cancellation message via a UE specific search space for the UE, wherein a scrambling sequence associated with the cancellation message is based at least in part on a UE identifier of the UE.

14. The UE of claim 12, wherein, to receive the cancellation message, the one or more processors are individually or collectively operable to execute the code to cause the UE to:
receive the cancellation message via a common search space associated with the UE, wherein a scrambling sequence associated with the cancellation message is based at least in part on a group radio network temporary identifier or a UE identifier of the UE.

15. The UE of claim 12, wherein the portion of the uplink message that is canceled corresponds to a primary cell for the UE and to one or more activated secondary cells associated with the UE.

16. The UE of claim 15, wherein the primary cell and the one or more activated secondary cells are associated with a same physical uplink control channel group, a same timing advance group, or both.

17. The UE of claim 12, wherein, to receive the cancellation message, the one or more processors are individually or collectively operable to execute the code to cause the UE to:
receive an indication of a priority of the uplink message relative to one or more other uplink messages, wherein cancelling transmission of at least the portion of the uplink message is based at least in part on the priority.

18. The UE of claim 12, wherein, to receive the cancellation message, the one or more processors are individually or collectively operable to execute the code to cause the UE to:
receive a start and length indicator value (SLIV), a resource indicator value (RIV), or both indicative of the portion of the uplink message that is canceled.

19. The UE of claim 12, wherein, to receive the cancellation message, the one or more processors are individually or collectively operable to execute the code to cause the UE to:
receive an indication of a bitmap indicating a set of time-frequency resources corresponding to the portion of the uplink message that is canceled, wherein the set of time-frequency resources corresponds to both the first subband and the second subband.

20. The UE of claim 19, wherein the bitmap comprises a first value indicating that the first subband is canceled for a duration of time and comprises a second value indicating that the second subband is not canceled for the duration of time.

21. The UE of claim 19, wherein the cancellation message comprises a first field indicating that both the first subband and the second subband are at least partially canceled and a second field indicating both a first subset of time-frequency resources within the first subband and a second subset of time-frequency resources within the second subband that are canceled.

22. The UE of claim 12, wherein the uplink message is at least one of an uplink control message or a random access message.

23. A method for wireless communications by a user equipment (UE), comprising:
receiving a control message indicating scheduling information for a downlink message that is scheduled for transmission via a first subband of a first radio frequency spectrum band and via a second subband of a second radio frequency spectrum band that is different from the first radio frequency spectrum band, the second subband being non-contiguous with the first subband, wherein the first subband and the second subband are associated with a virtual cell that supports communications for the UE;
monitoring the first subband and the second subband for the downlink message from the virtual cell based at least in part on the scheduling information; and
receiving a preemption message indicating that at least a portion of the downlink message is preempted, the portion corresponding to the first subband and the second subband.

24. The method of claim 23, wherein receiving the preemption message comprises:
receiving the preemption message via a UE specific search space for the UE, wherein a scrambling sequence associated with the preemption message is based at least in part on a UE identifier of the UE.

25. The method of claim 23, wherein receiving the preemption message comprises:
receiving the preemption message via a common search space associated with the UE, wherein a scrambling sequence associated with the preemption message is based at least in part on a group radio network temporary identifier or a UE identifier of the UE.

26. The method of claim 23, wherein the portion of the downlink message that is preempted corresponds to a primary cell for the UE and to one or more activated secondary cells associated with the UE.

27. The method of claim 26, wherein the primary cell and the one or more activated secondary cells are associated with a same physical uplink control channel group, a same timing advance group, or both.

28. A method for wireless communications by a user equipment (UE), comprising:
receiving a control message indicating scheduling information for an uplink message that is scheduled for transmission via a first subband of a first radio frequency spectrum band and via a second subband of a second radio frequency spectrum band that is different from the first radio frequency spectrum band, the second subband being non-contiguous with the first subband, wherein the first subband and the second subband are associated with a virtual cell that supports communications for the UE;
receiving a cancellation message indicating that at least a portion of the uplink message is canceled based at least in part on the scheduling information, the portion corresponding to the first subband and the second subband; and
canceling transmission of at least the portion of the uplink message based at least in part on the cancellation message.

29. The method of claim 28, wherein receiving the cancellation message comprises:
receiving the cancellation message via a UE specific search space for the UE, wherein a scrambling sequence associated with the cancellation message is based at least in part on a UE identifier of the UE.

30. The method of claim 28, wherein receiving the cancellation message comprises:
receiving the cancellation message via a common search space associated with the UE, wherein a scrambling sequence associated with the cancellation message is based at least in part on a group radio network temporary identifier or a UE identifier of the UE.
